(19) United States
(12) Patent Application Publication
(10) Pub. No.: US 2025/0014278 A1
(43) Pub. Date: Jan. 9, 2025

(54) POINTCLOUD PROCESSING, ESPECIALLY FOR USE WITH BUILDING INTELLIGENCE MODELLING (BIM)

(71) Applicant: POINTFUSE LIMITED, Maidenhead, Berkshire (GB)

(72) Inventors: George SKROBANSKI, Maidenhead, Berkshire (GB); Nicolas SPENCER, Maidenhead, Berkshire (GB)

(21) Appl. No.: 18/570,942

(22) PCT Filed: Jun. 17, 2022
(86) PCT No.: PCT/GB2022/051555

§ 371 Date: Dec. 15, 2023

(30) Foreign Application Priority Data
Jun. 18, 2021 (GB) 2108778.8

(51) Int. Cl. G06T 17/20; G06T 7/11; G06T 7/13; G06T 17/10

(52) U.S. Cl. CPC G06T 17/20; G06T 7/11; G06T 7/13; G06T 17/10; G06T 2207/10028; G06T 2207/20021; G06T 2210/04; G06T 2210/21; G06T 2210/52; G06T 2210/56

(57) ABSTRACT

Pointcloud processing, especially for use with Building Intelligence Modelling (BIM). A method of processing a point cloud to create a representation of objects in the point cloud, the method comprises: superimposing a grid of cubes over the point cloud; and for each cube in the grid, fitting a plane to the points in the cube, using the points in the cube and its neighbouring cubes, to produce a cube plane, and using the cube planes to derive a surface mesh of polygons.

Aspects of the invention relate to:
Pointcloud conversions to an intelligent mesh and
Texturing

Within the first of these a number of sub-sections cover the different elements up to and including BOLT (see below).

### Pointcloud Conversions

To convert a pointcloud (however derived) into an “intelligent” mesh where each separable planar surface (defined by break-lines) can be treated/processed individually ready for transfer (using a variety of industry standard formats) into other external software platforms eg Revit, Navisworks, Sketchup, etc. The process involves very considerable data compression thereby enabling the pointclouds to be operable on standard desk-top computers; where very large pointclouds are encountered they can be broken down using a methodology known as tiling (to be described).

Apart from the unique feature of producing an intelligent mesh (as explained separately) the Pointfuse processes retain all the relevant characteristics of the original pointcloud such that the accuracy of the final models relative to the original pointcloud can be represented on each section digitally or by using a heat map (by the application of standard deviation metrics).

### Problems to be Mastered

The issues which are met in practice include
corners (particularly where 3 planes meet)
non-straight lines
the edges of the pointcloud

The solution ideally needs to have no gaps (so hole-filling is a fundamental requirement) and be “watertight” (to enable for example 3D printed models to be created from the Pointfuse output.

### Methodology

The algorithms created use advanced statistical sampling and probability theory specifically applied. Earlier attempts to produce a robust suite of software foundered because the known mathematical theory was applied to the individual points: the resulting code became unworkable to deal with the very large number of “special situations”. This application relies on applying the same underlying theory to whole planes rather than the points themselves.

As well as planes, the same underlying methodology can be applied to other surfaces and objects, for example, to cylinders and pipes.

The invention has numerous applications, including, for example, for use with Building Intelligence Modelling (BIM).

The invention provides solutions to the above and other problems of the prior art. Aspects of the invention are set out in the claims.

The features of the dependent claims may also be applied to other methods that create a representation of objects using a point cloud, for example, by deriving a surface mesh of planes or polygons, such as the method of WO 2014/132020 A 1.

In other words, the invention also provides a method of processing point cloud data of objects to create a representation of the objects, the method further comprising the features of any of the dependent claims, alone or in combination.

For example, the disclosure encompasses a method of processing a point cloud including point cloud data of objects to create a representation of the objects, the method comprising:
superimposing a grid of cubes (or other volumes) over the point cloud;
for each cube in the grid, fitting a plane to the points in the cube, to produce a cube plane, and using the cube planes to derive a representation of the objects, in combination with the features of any of the dependent claims, alone or in combination.

### Contents

| | | |
|---|---|---|
| 1. | Introduction | 6 |
| 1.1 | Terminology | 6 |
| 2. | Pointfuse 1 | 7 |
| 3. | Pointfuse 2020 | 8 |
| 3.1 | Pointfuse Components | 8 |
| 3.2 | Pointfuse Kernel | 9 |
| 3.3 | Pointfuse Tiler and Tilefuse | 10 |
| 3.3.1 | Overview of Pointfuse Tiler and Tilefuse | 10 |
| 3.3.2 | The Pointfuse Tiler | 10 |
| 3.3.3 | Tilefuse | 11 |
| 4. | Converting Point Clouds to Triangular Meshes | 17 |
| 4.1 | Compute Smooth Surfaces | 17 |
| 4.1.1 | Smooth polygon mesh creation | 17 |
| 4.1.2 | Polygon node fusion | 20 |
| 4.2 | Polygon trimming | 21 |
| 4.2.1 | Build the work zone | 21 |
| 4.2.2 | Active contours | 24 |
| 4.2.3 | Cut the polygons with the trimming polylines | 27 |
| 4.3 | Computing Break Lines | 29 |
| 4.3.1 | Introduction | 29 |
| 4.3.2 | Surface trihedrons | 30 |
| 4.3.3 | Connected node sets | 30 |
| 4.3.4 | Surface contour lines | 30 |
| 4.3.5 | Normal curvature estimates | 31 |
| 4.3.6 | Estimation of the curvature tensor | 31 |
| 4.3.7 | High curvature nodes | 32 |
| 4.3.8 | Isolated nodes | 32 |
| 4.3.9 | Sign of curvature | 33 |
| 4.3.10 | Boundary nodes | 33 |
| 4.3.11 | Previous node table | 34 |
| 4.3.12 | Chain root node table | 35 |
| 4.3.13 | Analysing node chains | 35 |
| 4.3.14 | Break links and break nodes | 36 |
| 4.3.15 | Affected nodes | 36 |
| 4.3.16 | Clone split nodes | 37 |
| 4.3.17 | Binary nodes | 37 |
| 4.3.18 | Edge directions | 37 |
| 4.3.19 | Splitting polygons containing two break nodes | 37 |
| 4.3.20 | Splitting break polygon pairs | 37 |
| 4.3.21 | Splitting break polygon triplets | 38 |
| 4.3.22 | Break line graph | 39 |
| 4.3.23 | Triple nodes | 39 |
| 4.3.24 | Corner polygons | 39 |
| 4.4 | Building the Triangle Mesh Graph | 41 |
| 4.5 | Surface Simplification | 41 |
| 4.6 | Triangle Mesh Simplification | 43 |
| 4.6.1 | Overview | 43 |
| 4.6.2 | Maximum height from plane calculation | 44 |
| 4.7 | Close Break Edge Runs | 46 |
| 4.8 | Surface Texturing | 48 |
| 4.8.1 | Overview of surface texturing | 48 |
| 4.8.2 | Unwrapping the surface | 48 |
| 4.8.3 | Projecting point cloud points on to the bitmap | 49 |
| 5. | “Make Square” Functionality | 51 |
| 5.1 | Introduction to “Make Square” Functionality | 51 |
| 5.2 | Connected node triplets | 51 |
| 5.3 | Formulation as optimization problem | 52 |
| 5.4 | Solution algorithm | 52 |
| 5.5 | Computation of the constraint derivatives | 58 |
| 6. | Table | 60 |

### FIGURES

FIG. 1A tile (grey cube), containing exaggerated border regions (dotted cube) 1

FIG. 2 Top of two adjacent tiles and their border and overlap regions

FIG. 3 Removing, keeping and cutting triangles

FIG. 4 Discarding points in overlap area (left) and creating new points at tile edge (right)

FIG. 5 Mesh edge and node to be fused

FIG. 6 λ=fraction of distance b to c

FIG. 7 Edge Links

FIG. 8 Splitting edge links

FIG. 9 One node (shown larger) shared by many triangles

FIG. 10 When nodes are merged, the unique index number changes

FIG. 11 Edges added to mesh B triangle (left) and superimposed mesh A edges (right)

FIG. 12 How the position of nodes affects which triangles are split, and how

FIG. 13 Three step example: one triangle split twice

FIG. 14 Cut node positions within mesh A triangles

FIG. 15 Mesh B triangles superimposed on cut node positions

FIG. 16 Mesh B triangles split at cut node positions

FIG. 17 New cut nodes added to mesh B

FIG. 18 Mesh B polygons split at new cut nodes

FIG. 19 Mesh B after external triangles are removed

FIG. 20 Cross link external directions

FIG. 21 Cut nodes external directions

FIG. 22 Convex and non-convex nodes

FIG. 23 Triangle with one cross link

FIG. 24 Triangle with two cross links

FIG. 25 Primary and secondary cubes

FIG. 26 Cube vertex and edge labels

FIG. 27 Initialization of the work zone inward vector field

FIG. 28 Point cloud boundary estimation

FIG. 29 Surface trihedron

FIG. 30 Example mesh polygon

FIG. 31 High curvature nodes

FIG. 32 Isolated nodes

FIG. 33 Projecting chain nodes

FIG. 34 Independent and dependent root nodes

FIG. 35 Projection of chain nodes

FIG. 36 Insertion of break node

FIG. 37 Affected nodes

FIG. 38 Clone split nodes

FIG. 39 Edge directions

FIG. 40 Splitting polygons containing two break nodes

FIG. 41A break polygon pair

FIG. 42 Break nodes adjacent to a common node

FIG. 43 Side nodes adjacent to common node

FIG. 44A break polygon triplet

FIG. 45 An example triple node

FIG. 46A corner polygon

FIG. 47 An augmented corner polygon cluster

FIG. 48 Corner polygons with added embedded polygons

FIG. 49 Shape position

### TABLE

### Table 1 Polygon Winding Map

### 1. Introduction

### 1.1 Terminology

In this document:

### Boundary Node

A low curvature node that is adjacent to high curvature nodes along high curvature links and a t which the curvature does not change sign.

### Break Line

The line defined by the intersection of two distinct smooth surfaces.

### Edge Link

A mesh link that belongs to only one polygon.

### Edge Node

A node that belongs to an edge link.

### Grid Cube

A grid of cubes is superimposed over the region of space containing the point cloud. Any cube of this grid is called a grid cube.

### Neighbourhood Cube

The 3×3 cube comprising the primary cube and its 26 secondary cubes.

### Nodes

The vertexes of the polygon mesh.

### Point

A point in a point cloud.

### Polygon Mesh

Intersecting polygons. The links of the mesh correspond to one or more intersecting polygons.

### Primary Cube

Any individual grid cube.

### Root Node

A low curvature node that is adjacent to a boundary node along a contour.

### Secondary Cube

One of the 26 grid cubes that are adjacent to the primary cube.

### Tiles

Non-overlapping cubes of a point cloud. A tile is 3D, though with airborne Lidar and some of the simplified figures here, you may see only 2D.

### Vertex

Either a vertex of grid cube or a vertex of the planar intersection polygon formed by the intersection of a surface and grid cube.

### 2. Pointfuse 1

Pointfuse 1 converts a point cloud into planes (more strictly plane polygons) using the following steps, which are included in the recent Pointfuse patents (see WO 2014/132020 A1, the contents of which are incorporated herein by reference):
Superimpose a 3D grid of cubes over the entire point cloud.
Using principal component analysis, fit planes to the points within each grid cube. At the end of this step there is one plane for each grid cube.
Compare pairs of adjacent planes and, if they are sufficiently similar and are close enough, replace the plane pair by a single plane. Repeat this process until no further plane replacement is possible.
Compute the line of intersection of adjacent plane pairs. Where this line is sufficiently close to portions of the existing planes, extend those portions of the plane pairs to the line.

These steps result in a collection of plane polygons. At the borders of the point cloud, the polygon edges run along the grid cube faces. This looks fine if the plane is parallel to one of the cardinal planes, but otherwise the resulting polygons have unsightly zig-zag borders. In both cases, the polygon edges do not correspond with the position of the true point cloud border. Pointfuse 1 has an efficient statistically based method that corrects this error. This method was not included in the patent, and because it assumes the surfaces are planes, is not implemented in Pointfuse 2.

At this stage the surfaces are all still plane polygons. To display them on a computer screen, Pointfuse converts the polygons into a triangular mesh, using a standard triangulation method.

Finally, Pointfuse 1 can project the triangles of the 3D surfaces onto horizontal planes (plan view) or vertical planes (elevations). Pointfuse 1 implements Z-buffering to ensure that portions of (or all of) more distant triangles are correctly covered by nearer triangles.

### 3. Pointfuse 2020

### 3.1 Pointfuse Components

Pointfuse 2020 consists of the following distinct but inter-operable components:
Pointfuse Kernel is essentially a non-planar analogue of Pointfuse 1. It converts point clouds into separable triangular meshes. However (apart the use of a 3D cube grid) it uses a completely different algorithm. For example, triangular meshes are an integral part of the algorithm. And, unlike Pointfuse 1, the triangular meshes can (and often do) represent non-planar surfaces.
Pointfuse Tiler and Tilefuse. The Tiler splits the point cloud into distinct (but overlapping) regions called tiles. The Pointfuse Kernel can then be applied independently to the point cloud within each tile to obtain one or more separable meshes in each tile. Tilefuse fuses together the meshes in such a way that separable meshes are correctly identified across tile faces, thus preserving one of Pointfuse's unique selling points.
Pointfuse Bolt uses Microsoft Azure to run parallel instances of the Pointfuse Kernel in the cloud. Pointfuse Bolt is responsible for uploading tiles to the cloud, invoking Pointfuse Kernel, and then downloading the converted meshes. Tiling and assembly are performed on the user's desktop.
Pointfuse Multicore tiles the point cloud, runs parallel instances of the Pointfuse Kernel (one for each tile) in the separate cores of the user's desktop, and then runs Tilefuse to assemble the resulting sub-meshes together.
Pointfuse Mesh Functionality. In addition, Pointfuse 2020 has optional functionality which can be applied to the generated meshes.
Pointfuse Space Creator Functionality simplifies Pointfuse meshes into a form that can be readily passed to third party software, especially for use with Building Intelligence Modelling (BIM). An aspect of this covered by this description is the Make Square Functionality which automatically modifies angles between walls in floor plans.

### 3.2 Pointfuse Kernel

Pointfuse Kernel converts a point cloud into one or more separable meshes. It comprises the following steps.
Superimpose a 3D grid of cubes over the entire point cloud. This is the only step that is the same as in Pointfuse 1.
Use principal component analysis to fit planes to each cube. Unlike in Pointfuse 1, the plane is fitted using the points in 27 grid cubes (the central cube and its 26 neighbours). This approach generates local planes that more closely follow surfaces. The planes tend to be coterminous with and have similar orientations to planes in adjacent cubes. However in regions with high curvature (such as where two or more distinct surfaces meet) the generated surfaces are discontinuous, having ugly tears or rips, and the plane orientation may bear no relation to the corresponding local surface.
The surface discontinuities are removed by sealing the surfaces. This is done by constructing an average plane at each cube vertex. As its name reveals, the average plane is defined as the average of the smoothed planes fitted in the eight cubes that share each vertex. The distance of each cube vertex to the fitted surface is computed as the distance of that vertex to its average plane. This process defines a scalar field at each cube vertex. This scalar field can be linearly interpolated along every cube edge to give the position at which the surface intersects that edge. Unlike planes fitted in cubes, this interpolated surface is common to all four cubes that share that edge. The surface is therefore continuous. However it means that at edges, where two or more surfaces meet, the edge is rounded or bevelled in appearance.
Each grid cube has 8 vertexes and 12 edges. Each surface can intersect one or more vertexes and/or edges. There are thus a finite number of possible combinations of surface topologies for the surface. These can be listed in a look-up table, making the calculation of the sealed surface very efficient. This technique is similar to that used in the method of marching cubes, however:
   There are significantly more possible combinations and
   The scalar field has been obtained by statistical estimation of a point cloud, rather than by scanning the density of a solid body.
The break lines process replaces some of the bevelled edges by linearly extrapolating the adjacent surfaces to a common line of point of intersection.
Polygon trimming is used to fit the resulting surfaces to the point cloud borders.
At this stage the computed surface still consists of a separate polygon for each cube. The polygon is then split into separate triangles.
Triangle simplification.
Hole filling.
Unwrapping textures and colour accumulation.

### 3.3 Pointfuse Tiler and Tilefuse

### 3.3.1 Overview of Pointfuse Tiler and Tilefuse

The Pointfuse Tiler and Tilefuse enable Pointfuse to handle point clouds of unlimited size. The Tiler partitions the point cloud into one or more non-overlapping cubes called tiles. The Tiler then allocates those points into a collection of sub point clouds. Each sub point cloud contains the point cloud points that lie within the tile or lie within a narrow border region surrounding the tile.

The Pointfuse algorithm is applied individually (either sequentially or in parallel) to every sub point cloud, resulting in completely separate meshes in each tile. Each tile mesh may itself contain several separate surfaces. For example, one surface may represent the floor of a room, and another surface may represent a wall.

Tilefuse fuses the separate tile meshes into a single mesh in such a way that the separate surfaces within each tile are fused to the appropriate surfaces or surfaces in neighbouring tiles.

### 3.3.2 The Pointfuse Tiler

The Pointfuse Tiler partitions space into tiles. The length of each side of the tile is a multiple of the length of the grid cubes. By experimentation we have found that a tile size of 250 times the grid cube size results in fast run times. But other multiples, including non-integer multiples, can be used.

The Tiler allocates the point cloud points within each tile, and within a narrow overlap region surrounding the tile to a sub point cloud.

The overlap region extends a multiple of the grid cube length outwards from the tile in the positive and negative X, Y and Z directions. In one embodiment of the invention, the overlap region extended 5 grid cubes from the tile. Other multiples, including non-integer multiples, can be used.

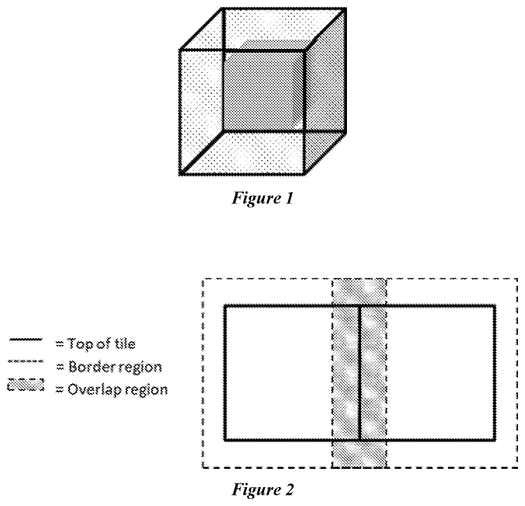

FIG. 1 illustrates a tile and, in exaggerated size, the tile border regions. FIG. 2 is a two dimensional representation of two adjacent tiles, showing how their border regions overlap.

### 3.3.3 Tilefuse

Tilefuse is presented with a collection of tiles. Each tile contains a mesh which itself may be composed of sub meshes which are referred to here as surfaces. Each surface is distinct except that it may share nodes with adjacent surfaces in the same tile. Each surface may extend across the tile's six faces into neighbouring tiles. Tilefuse cuts each surface to ensure that the surface ends at the tile face. As a result of the surface cutting, some surface nodes now lie directly on the tile face.

Tilefuse now iterates through all the common tile faces (tile faces that belong to two tiles). Each common tile face has two adjacent tiles. Within each adjacent tile there is a mesh consisting of separate surfaces. If a surface has nodes or edges that lie on the tile face, it may be necessary to fuse those nodes and edges with the corresponding nodes and edges of a surface in the matching tile on the other side of the tile face.

### 3.3.3.1 Cutting Surfaces

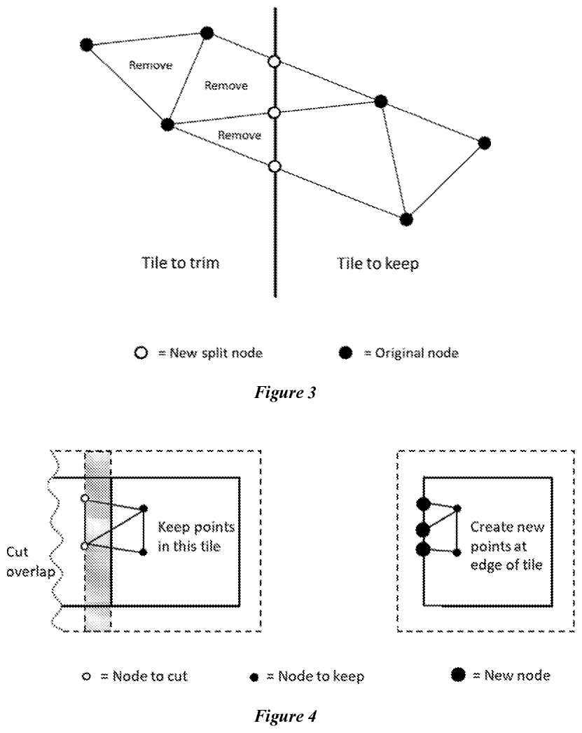

Surfaces within each tile are cut by considering each triangle in turn. If all three triangle nodes lie inside the tile, or on the tile face, the triangle is left unchanged. If all three nodes lie strictly outside the tile, the triangle is removed from the surface. Otherwise, one of the triangle nodes must lie on the other side of the tile from the other two nodes. Two triangle edges must therefore cross the tile face. All such tile face crossing edges are identified. Usually they will belong to two triangles in the surface. All triangle edges that cross the tile face are split into two by adding a new split node at the position where the edge crosses the tile face. (Exception: if the position of a split node lies close to one of the edge nodes, that edge node is moved to the position of the split node and the edge is not split.) In FIG. 3, the vertical line represents the tile face. The nodes to left lie outside the tile and must be removed. The nodes to the right will remain.

Once this process has been completed, the affected mesh polygons have either three, four or five nodes. If an affected polygon has only three nodes, no further action is required. Otherwise two of the polygon nodes are split nodes. If these two polygons do not already share an edge, the polygon is split along the line joining the two split nodes. The resulting two separate polygons lie on opposite sides of the tile face. The polygon that lies outside the tile is removed from the surface. If the remaining polygon has four nodes, it is split into two triangles, both of which lie inside the tile. FIG. 4 illustrates how the edges of two adjacent triangles might be cut and become a triangle and a quadrilateral.

### 3.3.3.2 Identifying Nodes and Edges to be Fused

Once the external portions of the meshes have been removed, the meshes in adjacent tiles may be fused (that is combined) to form a single mesh. Meshes represent distinct surfaces so they are only fused if the angle between the planes of adjacent triangles are sufficiently small.

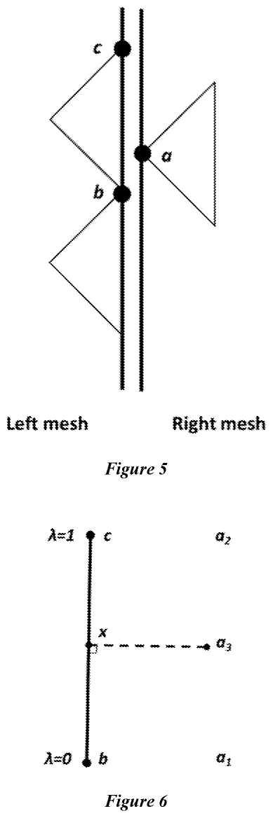

Nodes and edges to be fused are identified by establishing their proximity to sufficiently close nodes and edges in a matching surface on the other side of the tile face. For example FIG. 5 shows an edge b, c that will be fused with a nearby node a on the other tile face.

Let aₖ∈ [symbol] ³ be the position of one or more nodes in a surface. And let b∈ [symbol] ³ and c∈ [symbol] ³ be the positions of the end nodes of an edge in the matching surface. The point on the straight line through b and c that is nearest to aₖ is:

$${x}_{k} = b + {λ}_{k} ( c - b )$$

$$where :$$

$${λ}_{k} = \frac{{( {a}_{k} - b )}^{T} ( c - b )}{{( b - c )}^{T} ( b - c )}$$

If λₖ is sufficiently close to zero then λₖ is set to zero and aₖ will be fused with b.

If λₖ is sufficiently close to unity then λₖ is set to one and aₖ will fused with c.

Otherwise if 0<λₖ<1 then aₖ will be fused with a new node on the edge.

Otherwise aₖ will not be fused.

For example, in FIG. 6 node a₁ is fused with the end node b, node a₂ is fused with end node c, and node a₃ is fused with a new node at the position x.

The values λₖ and aₖ are stored in increasing order of λₖ for each edge b, c.

### 3.3.3.3 Splitting Edges Before Fusing Meshes and Nodes

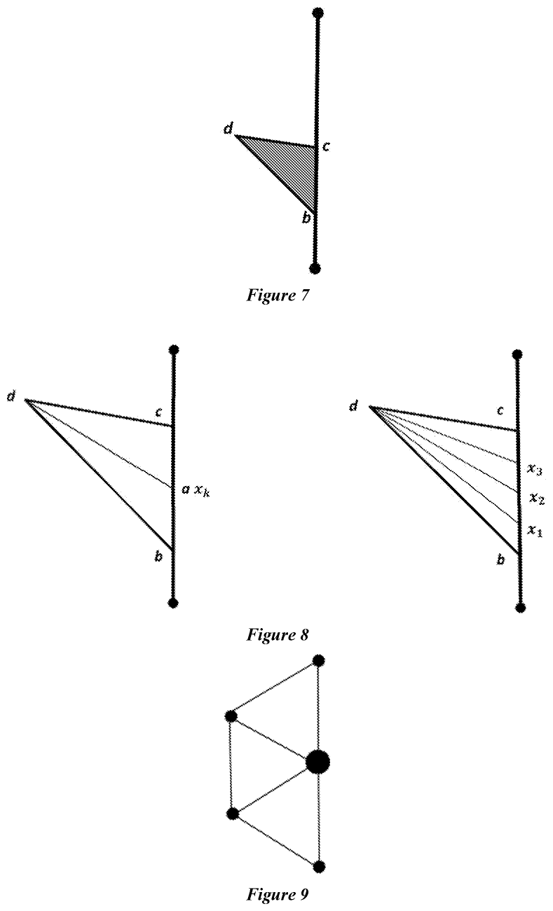

Each edge b, c that potentially can be fused lies along the tile face is the base of a triangle whose apex node d lies strictly in the tile or on the tile face. See FIG. 7. If the edge b, c possesses at least one 0<λₖ<1 (where both inequalities are strict) then the triangle is split at each xₖ that is not sufficiently close to b or c by joining xₖ to the apex node d. The nodes xₖ (which now may include b and/or c) will be fused with the corresponding aₖ.

For example, in FIG. 8 (left), the edge b, c is split at a single new node x₁. In FIG. 8 (right), the edge is split into three new nodes x₁, x₂, x₃.

### 3.3.3.4 Fusing the Nodes

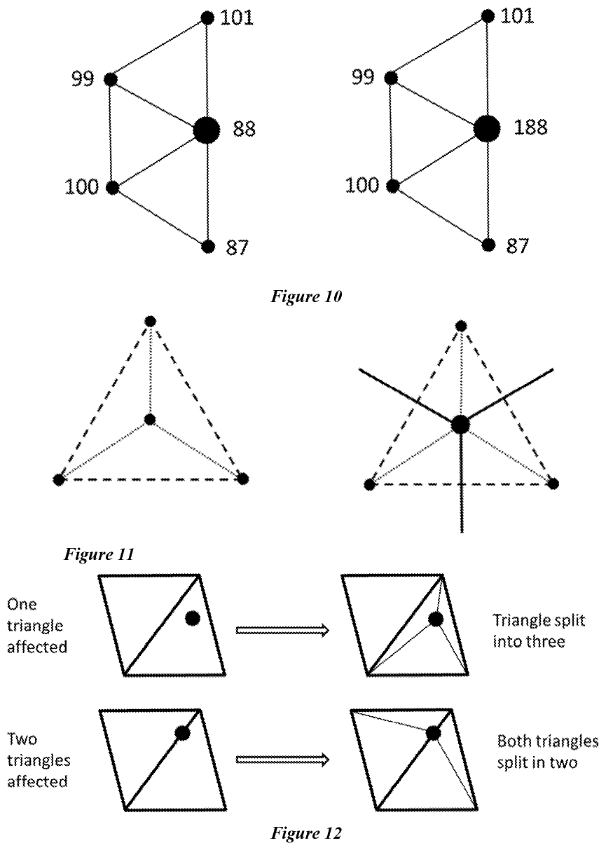

Usually only single pairs of nodes are fused. Suppose the nodes being fused are A and B, with B being the node in the matching surface. Both nodes are moved to their common mean position. The matching node B is replaced by A in every triangle that B belongs to. FIG. 9 illustrates a fused node that belongs to three distinct triangles. The node is replaced by changing its index number. FIG. 10 illustrates a node 88 being replaced by node 188.

In the more general but rarer case, m nodes A₁, . . . , Aₘ in a surface and n matching nodes B₁, . . . , Bₙ a matching surface are to be fused. In this case, all the nodes are moved to their common mean position and all nodes are replaced by A₁ in every triangle that they belong to.

If the fused nodes belong to same surface (because the two surfaces were fused at an earlier stage) then no further action is required.

However if the fused nodes in the matching tile belong to a different then all the other nodes in the matching surface must also re-indexed to ensure that their labels are different from those in the current surface.

### 3.3.3.5 Aligning Matching Surfaces that are Parallel to a Tile Face

Consider a point cloud representing a surface that crosses a tile face. The portions of the surface on either side of the tile face are modelled by two completely independent processes in the two tiles. The two modelling processes separately generate two plane meshes that approximate the single point cloud surface. Because the two processes will in general work through the grid cubes in different orders, the two meshes will not be in perfect alignment.

Usually this misalignment is negligible. However when the surface is parallel, or nearly parallel, to the tile face, then even small discrepancies in the two meshes may result in the two surfaces crossing the tile face at significantly different locations.

To avoid this issue, meshes that are parallel or nearly parallel to the tile face, are first aligned to each other. This is done as follows:

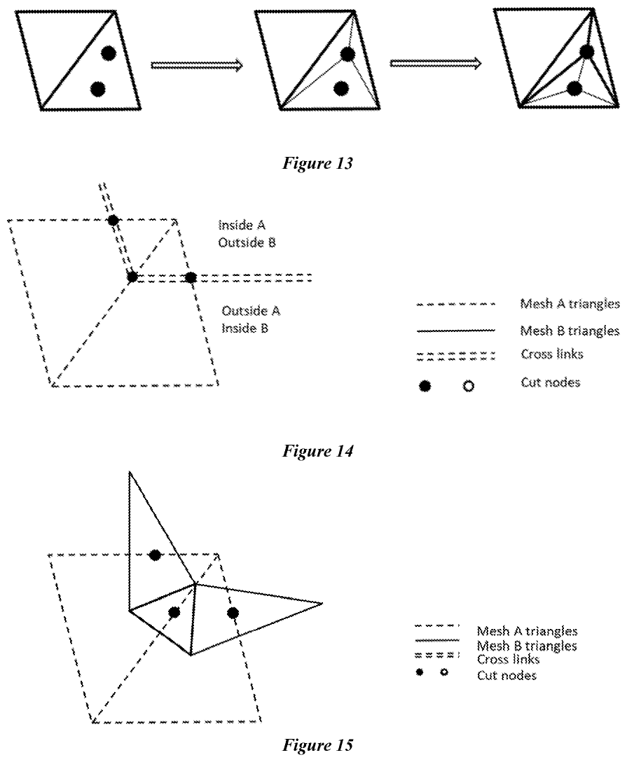

Let the two meshes be labelled A and B.
1. Project all the nodes in mesh A onto mesh B, storing the projected positions, and their containing triangles, for use as new nodes in mesh B. The projection is done in the direction that is normal to the tile face and outwards from the tile in which mesh A was constructed. If the projection line intersects a triangle of mesh B, then the new projected node is located at the position of intersection. If the projection line intersects more than one triangle then the intersection position nearest to the mesh A node is used. If no triangle is intersected, or if the (nearest) triangle is sufficiently distant, or if the projected position is sufficiently close to one of the existing mesh B nodes, the point is not projected.
2. Split the mesh B triangles at the new projected nodes they contain. Each triangle in mesh B is considered in turn. If it contains one of the new nodes generated by Step 1, the triangle is split at the position of the new node into sub-triangles. If the original triangle contained more than one new node, the other new nodes are allocated to the sub-triangle they are contained in. For example in FIG. 13 a triangle to be split also contains a second new node. The triangle is split at the first new node into three distinct sub-triangles. The sub-triangle containing the second new node is then split into a further three sub-sub-triangles. Usually the original triangle will be split into three sub-triangles as in the top diagram FIG. 12. However if the new node is sufficiently close to an edge of the existing triangle, then the new node is positioned precisely on the edge and the original triangle is only split into two. In this case, the split edge may also belong to another triangle. This second triangle must also be split into two sub triangles, as in the bottom diagram in FIG. 12. Any new nodes contained in the second triangle must be allocated to the sub triangle they are contained in. As each projected node (either new or existing) in mesh B is identified, it is associated with the mesh A node that is being projected. The left hand diagram in FIG. 11 shows the mesh A edges, where the dashed lines indicate an original triangle and the dotted lines indicated the new edges that were added. In the right hand diagram, the mesh A edges (solid lines) are superimposed over the mesh B edges (dashed and dotted lines). The process is repeated until all the mesh B triangles containing new nodes have been split.
3. Repeat steps 1 and 2 with mesh A and mesh B interchanged.
4. In Step 2, each projected node in mesh A has been associated with a unique projection node in mesh B. The projected and projection nodes are moved to their mean position.
5. Repeat Step 4 with mesh A and mesh B interchanged.

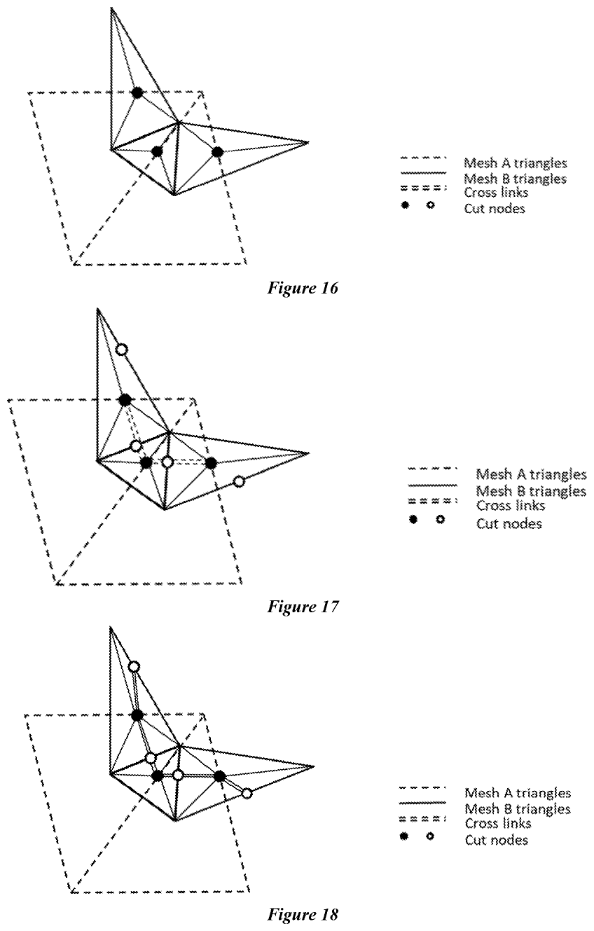

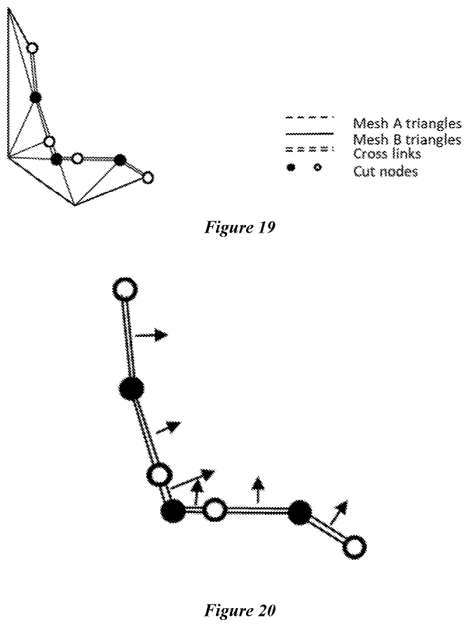

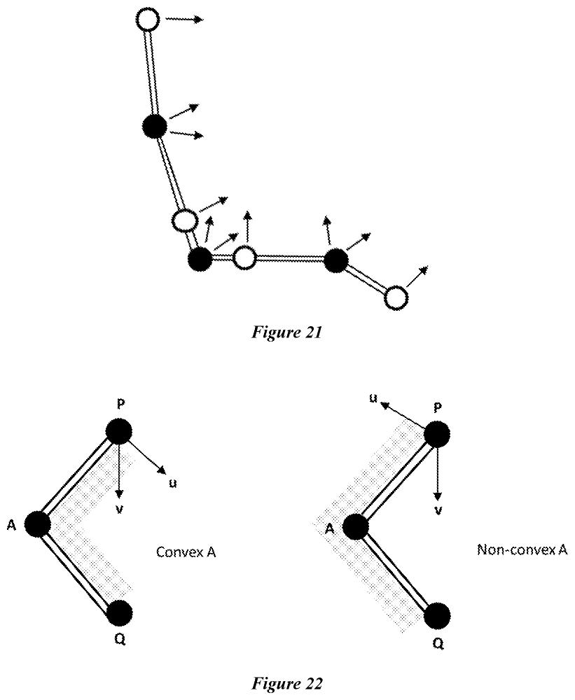

Notice that, so far, analogous alignment changes have been made to both mesh A and mesh B. Steps 6 to 13 analyse mesh A, but make changes only to mesh B:
6. Find the positions (called cut nodes) at which all links in mesh A cross the tile face. The cut nodes are the positions at which mesh A will subsequently be cut (as described in Section 3.3.3.1) but the cut is not performed at this stage. Here the positions are used to modify mesh B so that the two cut surfaces are correctly aligned. FIG. 14 shows an example of cut nodes in mesh A. (See Step 9 for a discussion of the cross links.)
7. Using the method of Step 1, project the cut node positions onto mesh B. FIG. 15 shows the example cut nodes of FIG. 14 superimposed on mesh B triangles. (Mesh A edges are drawn dashed, mesh B edges are solid.)
8. Using the method of Step 2, split the mesh B triangles at the projected cut node positions. FIG. 16 shows the result when the mesh B triangles in FIG. 15 have been split at the cut nodes.
9. Construct cross links. These are line segments that join cut nodes that belong to the same triangle in mesh A. In FIG. 14 the cross links are shown as double dashed lines.
10. Identify the positions at which each cross link cuts across existing links in mesh B. These positions include the existing cut nodes at either end of the cross links. FIG. 17 shows the position of the new cut nodes in the mesh B edges of FIG. 16. Insert any new cut nodes in the mesh B links at the intersection positions. FIG. 18 shows the result when the new cut nodes are added to mesh B. Use the method of Section 3.3.3.1 to:
   a. Split any mesh B triangles that contain cross links
   b. Remove the half that lies outside tile B and and
   c. If necessary split the half inside to sub triangles.
   FIG. 19 shows the result when the external triangles have been removed from mesh B in FIG. 18.
11. Each cross link lies along the tile face. Identify the unique unit vector that lies in the triangle plane, is orthogonal to the cross link, and points outwards from tile B (the tile that contains mesh B). This unit vector is called the external direction of the cross link. Store the external direction for each cross link. FIG. 20 shows the external directions for the cross links in FIG. 19.
12. Classify the cut nodes. Each cut node belongs to either one or two cross links. It will therefore have one or two external directions associated with it. Store the external directions associated with each cut node. FIG. 21 shows the external directions associated with every cut node in FIG. 20. If the cut node has two external directions associated with it, it can be classified as being convex or non-convex. (More precisely, the external region is locally either convex or non-convex at A). In detail, let A be the cut node being classified. Let AP and AQ be the two cross links that A belongs to. That is P and Q are cut nodes that share a cross link with A. Let û∈ [symbol] ³ be external direction associated with cross link AP and let \hat{v}∈ [symbol] ³ be the unit vector along the line from P to Q. Then the external set (the portion of mesh B that lies outside tile B) is convex at A if û^{T}\hat{v}≥0. Otherwise the external set is non-convex at A. See FIG. 22 where the shading indicates the side of the cross links that is in the external region.
13. Remove boundary triangles in mesh B. A triangle in mesh B is a boundary triangle if:
   a. It has at least one edge that is a cross link
   and
   b. It is external to tile B.

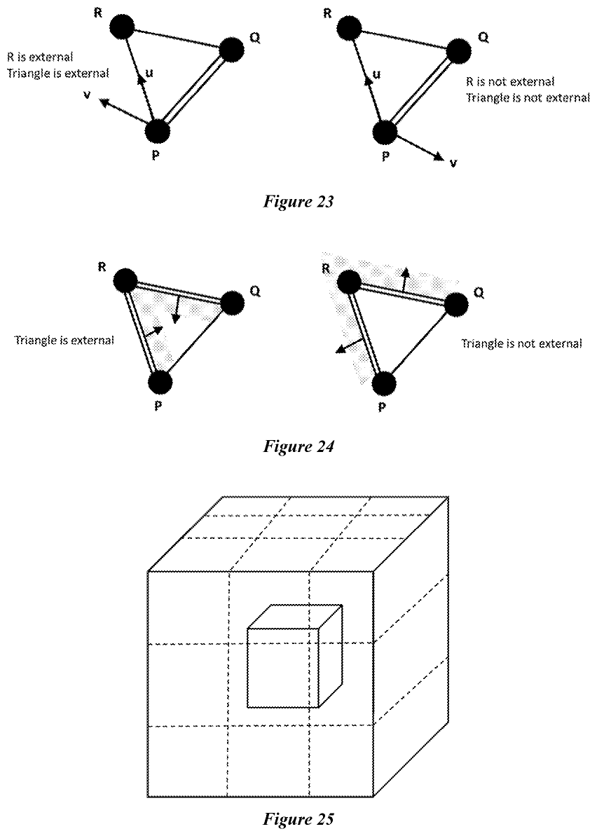

If a triangle PQR only has one edge PQ that is a cross link then the triangle is external if the node R lies outside tile B. In more detail, let the position of the triangle vertexes be p, q, r∈ [symbol] ³, let u=r−p and let v be the external direction at P. Then triangle PQR is external if u^{T}v>0. See FIG. 23. If the triangle PQR has two edges that are cross links, suppose that edges RP and RQ are cross links, then triangle PQR is external if the external set is convex at R. See FIG. 24 where the shading indicates the side of the cross links that is in the external region. If all three edges of a triangle are cross links, the triangle is external if the external set is convex at any of its vertexes.

### 4. Converting Point Clouds to Triangular Meshes

### 4.1 Compute Smooth Surfaces

### 4.1.1 Smooth Polygon Mesh Creation

### 4.1.1.1 Fit Planes to Each Grid Cube

A grid of cubes is superimposed over the region of 3D space containing the point cloud. In what follows, a primary cube is any individual grid cube. Secondary cubes are the 26 grid cubes that are adjacent to the primary cube. The neighbourhood cube is the 3×3 cube comprising the primary cube and its 26 secondary cubes. See FIG. 25. Principal component analysis is used to fit a plane to the primary cube, using the position of all the point cloud points in the entire neighbourhood cube. In detail, let the position of the point cloud points be xₖ ∈ [symbol] ³. Then the centroid of these points is

$$\overline{x} = \frac{1}{n} {\sum }_{k} {x}_{k} ,$$

where the summation is over all point cloud points in the neighbourhood cube, and n is the number of point cloud points in the neighbourhood cube. The covariance matrix W∈ [symbol] ^{3×3} of these points is:

$$W = \frac{1}{n} {\sum }_{k} ( {x}_{k} - \overline{x} ) {( {x}_{k} - \overline{x} )}^{T} = \frac{1}{n} {\sum }_{k} {x}_{k} {x}_{k}^{T} - \overline{x} {\overline{x}}^{T}$$

where the superfix T indicates the transpose. The plane is computed in the form a^{T}(x−x̅)=0 where a∈ [symbol] ³ is the plane normal and is the (unit) eigenvector corresponding to the smallest eigenvalue of the covariance matrix W. The plane can also be written in the form a^{T}x=β where β=a^{T}x̅ is the displacement (signed distance) of the centroid from the plane. Note that the computed plane may not intersect the primary cube. Note also that it may not be possible to fit a plane to the point cloud points (for example if there are less than three point cloud points in the neighbourhood cube). The computed plane is flagged as valid if it intersects the primary cube.

### 4.1.1.2 Fit Planes to Each Grid Vertex

Once a plane has been fitted to every grid cube, a vertex plane can be fitted at all the grid vertexes. (The vertex plane does not in general pass through the vertex, but is valid in the region surrounding it.) Each grid vertex belongs to eight grid cubes. In general a valid plane (called here a cube plane) has been fitted to each of these grid cubes. (There may be less than eight cube planes if some have been bound to be not valid). The vertex plane is an average of the valid grid planes and is computed as follows. Let the cubes planes be aₖ^{T}x=βₖ. Compute the symmetric positive semi-definite matrix A=Σₖaₖaₖ^{T}, where the summation is over the valid neighbouring cube planes. Let λ be the largest eigenvalue of A and let a∈ [symbol] ³ be the corresponding (unit) eigenvector. Then the vertex plane is a^{T}x=β where

$$β = \frac{1}{λ} {\sum }_{k} ( {a}_{k}^{T} a ) {β}_{k} ,$$

where the summation is over valid the neighbouring cube planes. To see how this formula for β arises, note that by definition Aa=λa, that is

$$a = \frac{1}{λ} Aa = \frac{1}{λ} ( {\sum }_{k} {a}_{k} {a}_{k}^{T} ) a = {\sum }_{k} {w}_{k} {a}_{k} , where {w}_{k} = \frac{1}{λ} {a}_{k}^{T} a .$$

Similarly β=Σₖwₖβₖ.

### 4.1.1.3 Compute which Vertices and Edges of the Cube are Intersected

A surface (treated locally as a plane) can intersect a cube at one or more of its vertexes and/or through one or more of its edges.

Consider the cube vertex Vᵢ. Let the vertex plane at Vᵢ be aᵢ^{T}x=βᵢ. The displacement (or signed distance) of Vᵢ from the vertex plane is dᵢ=aᵢ^{T}Vᵢ−βᵢ. Then the surface is deemed to intersect the cube at Vᵢ if |dᵢ|<0.001 h, where h is the resolution (the size of each grid cube).

Now consider the cube edge Eᵢⱼ joining cube vertexes Vᵢ and Vⱼ. If the surface intersects the cube at either Vᵢ or Vⱼ, it is deemed not to intersect the edge Eᵢⱼ. So in what follows it is assumed that the surface does not intersect the cube at either Vᵢ or Vⱼ. Then both dᵢ and dⱼ are non-zero. The sign (the orientation) of the normals is arbitrary. For consistency it is therefore necessary to change the sign of the normal aⱼ if aᵢ^{T}aⱼ<0. This in turn changes the sign of βⱼ and dⱼ. We now treat the displacement as a linear function along the edge of Eᵢⱼ. If dᵢ and dⱼ have the same sign (by construction neither can be zero) then the linear displacement function cannot be zero along the edge.

However if dᵢ and dⱼ have opposite signs, then by linear interpolation the displacement is zero at the position V=(1−λ)Vᵢ+λVⱼ where λ=dᵢ/(dᵢ−dⱼ).

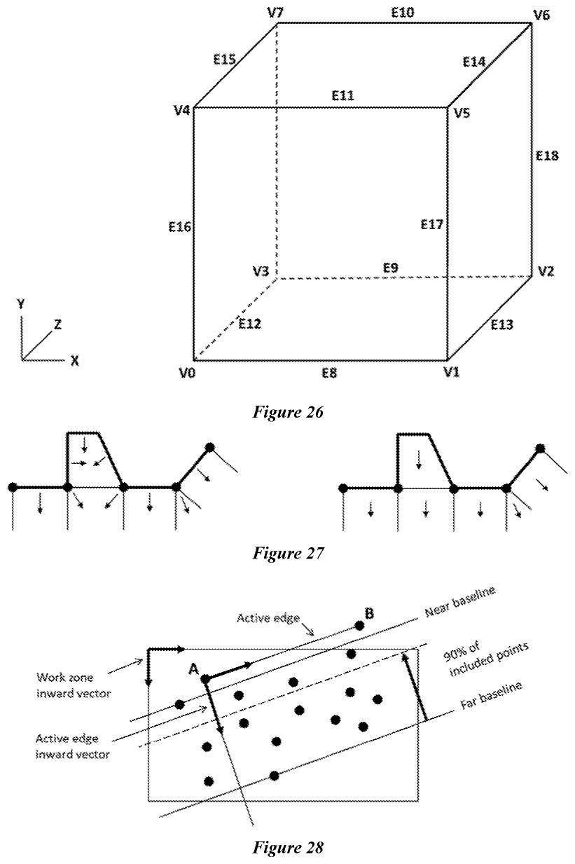

The vertexes and edges that are intersected by the surface can be stored as a bit pattern as follows. Give the eight cube vertexes and 12 cube edges unique indexes in the range 0 to 19 as indicated in FIG. 26 (where the prefix E and V signifies whether the index refers to an edge or vertex). Initialize all the bits to zero. Set the corresponding bit of the integer to one if the surface intersects that edge or vertex. For example, if the plane intersects the four vertexes V0, V1, V2, V3, then the 20-bit bit pattern is 0000 0000 0000 0000 1111, which corresponds to the integer 15=2³+2²+2¹+2⁰. Each set of intersections forms a polygon. The winding order lists the vertexes in order around the polygon. Table 1 lists all 615 possible polygons (excluding degenerate cases, where the polygon has less than three vertexes). It would be possible to reduce the number of entries by taking account of symmetry and rotation, but because the list is intended for use by computer, there is little advantage to doing so.

If a cube grid does not possess a valid plane but has a vertex plane at each of its 8 vertexes, then those 8 vertex planes are used compute the intersection polygon, as described above.

### 4.1.1.4 Re-Compute Planes of Cubes Whose Polygons do not have a Valid Winding Vertex Set

The planes of cubes whose polygons do not possess a valid winding vertex set are recomputed as follows. Let the smoothing cube set consist of all cubes which do not possess a valid winding vertex set.
1. Compute the smoothing growth cube set to consist of all cubes that:
   a. Are neighbours of the smoothing cube set
   b. Have valid planes
   and
   c. Are not themselves members of the smoothing cube set.
2. Recompute the vertex planes at each vertex of the smoothing cube set by fitting each vertex plane to the point cloud points in the 64=4×4×4 cubes centred on the vertex. Recompute the resulting intersection polygons of these cubes.
3. The intersection polygons in the cubes in the smoothing growth cube set are recomputed to ensure that the polygons are consistent with the cube's eight vertex planes, some of which may have been recomputed.

Any cubes which now have valid winding vertexes are removed from the smoothing cube set and the above steps 1 to 3 are repeated for each cube in the updated smoothing cube set.

We have not found it necessary to repeat steps 1 to 3 more than once.

### 4.1.1.5 Merge Coplanar Polygons to Remove Local Loops

This procedure is applied to the intersection polygons of pairs of adjacent cubes. It computes the distance between vertexes of the two polygons. The vertexes are deemed to be shared (the same) if the distance between them is less than a specified fuse tolerance. A suitable value for the tolerance is one tenth the length of a grid cube side. If the number of shared vertexes is less than three then no action is taken. Otherwise the two polygons must be coplanar. They are replaced by a single polygon that contains their combined vertexes (each shared vertex treated as one vertex) in the correct order around the combined polygon perimeter.

### 4.1.1.6 Erase Polygons that do not have Shared Edges

The edges of intersection polygons in adjacent cubes are compared. Polygons with more than one shared edge will have already been merged at the previous step. Any polygons without a shared edge are erased.

### 4.1.1.7 Erase Polygons Whose Cubes do not have any Points

This trimming stage removes polygons that are both:
1. In cubes that do not contain point cloud points
and
2. Connected to other polygons by only one vertex or edge

### 4.1.2 Polygon Node Fusion

The smooth polygon creation stage ensures that surfaces meet exactly between adjacent faces of each grid cube. This step fuses together the nodes shared between the faces of grid cubes to make a contiguous surface.

### 4.1.2.1 Find Indexes of Nodes within Adjacent Grid Cubes that Need to be Fused

Build change sets of polygon node indexes (sets of nodes that lie within the fusion tolerance of each other). All the nodes within a change set will be fused together and their indexes will be set to a single value. This includes nodes within the same polygon. It is possible that the change set will cause polygon butterflies (non-consecutive repeated node indexes).

### 4.1.2.2 Combine Non-Disjoint Change Sets

Each node can fuse itself with any neighbouring nodes within the threshold distance. This step merges these neighbouring nodes together. This widens the fusion region but often resolves polygon butterfly issues.

### 4.1.2.3 Fuse the Nodes in Each Change Set Together

Fuse the nodes in each change set together. Fusing nodes can cause the following issues:
1. Polygon with duplicate vertexes (short edges, butterflies)
2. Polygons that partially overlap other polygons (three or more shared nodes); these are caused by nearly coplanar planes nearly parallel to the cube faces.

### 4.1.2.4 Remove Short Edges

This clean up step removes duplicate polygon nodes (short edges). This step can generate polygons with only one or two vertexes. These polygons are removed.

### 4.1.2.5 Duplicate Polygon Remover

This clean up step removes duplicate polygons. That is polygons that consist of the same nodes, either in the same or reverse order.

### 4.2 Polygon Trimming

The purpose of this calculation is to trim the polygon mesh to an estimate of the point cloud boundary.
1. This is an active contour approach that shapes the outer contour of the mesh to the point cloud boundary.
2. An iterative process of contour polyline smoothing and driving towards the edges of the point cloud is used to determine the boundary.
3. The final part of the process is to cut the mesh with the contour polyline and trim away that portion that is outside of the point cloud.

### 4.2.1 Build the Work Zone

This determines which polygons the active contour polyline can wander through to progressively move towards the point cloud boundary. An inward vector is calculated for each polygon in this work zone that determines which way the nodes of the active contour should travel. The work zone is built gradually, starting from the polygons connected to the outer contour of the mesh. Additional polygons are added to this set by gluing neighbouring polygons within 3 grid cubes distance of the outer contour.

### 4.2.1.1 Outer Contour Polylines

The boundary edges of the mesh can be found by building a map of edges that link neighbouring polygons. The non-shared edges in this map identify the boundary edges. These unordered edges can be used to trace a path around the contour of the mesh to form a complete boundary polyline.

A map of nodes connecting unordered boundary edges must be built to trace the required edges around the contour. Outer contours of the mesh can legitimately touch at nodes where the mesh contains cavities. In cases where there are many possible outgoing edge links from a node, the edge whose connected polygon plane conforms most with the current surface normal is chosen.

### 4.2.1.2 Erode Empty Polygons Connected to the Outer Contour of the Mesh

Erode any polygons connected to the outer contour whose grid cubes do not contain any points. The outer contour polyline is subsequently updated after removing these polygons. This is performed to ensure the active contour can lock onto the nearby point cloud.

### 4.2.1.3 Work Zone Polygon Planes and Inward Vectors

Polygon planes are computed from the vertices of the polygon. Each plane has a basis frame at the polygon centre with principal axes aligned with the inward vector, plane normal and a third unit vector, the binormal, orthogonal to both.

The work zone polygon planes and inward vector field are computed as follows:
1. A polygon may have one or more edges connected to the outer contour of the mesh. The inward vectors associated with each polygon edge are accumulated and normalized on a per polygon basis.
2. The inward vector for a polygon (edge) connected to the mesh boundary is determined from the vector orthogonal to both the edge direction and the plane normal (with the condition that it lie on the same side as the mid-edge to polygon centre vector). The depth of these polygons is set to zero.
3. Polygons may also be connected to the outer contour by a single node only. In this case the inward vector is computed from the contour touch point to polygon centre vector (projected onto the polygon plane). The depth of these polygons is also set to zero. See FIG. 27, which illustrates the initialization of the work zone inward vector field.
4. The work zone is expanded by growing the grid cubes by one to find the inner work zone polygons. A new map between polygon edges and polygon planes is created to determine connectivity. Polygon planes are calculated and added to the work zone in depth incremental order (a polygon of depth+1 is added if it is edge-connected to a polygon of the current depth).
5. Another grid cube growth is performed to extend the working zone. A 3-window of grid cubes are gathered around any polygon associated with a non-shared edge in the new polygon edge map. The same depth incremental creation of polygon planes and addition to the work zone is performed as above.
6. Inward vectors are then combined in depth progression order to complete the inward field. All polygons not connected to the mesh border (depth>0) are gathered from the work zone. They are processed and removed from this set when they are edge connected to the current depth iteration. The inward vector for the polygon plane is accumulated from those edge-connected polygons with lower depth value. At each step the averaged inward vector is normalized and projected onto the polygon plane. This ensures that inward vectors are successfully driven round bends in the mesh.

### 4.2.1.4 Work Zone Point Cloud Samples for Active Contour Driving

This stage builds a local search horizon for each polygon within the work zone. Each polygon plane maintains links to its neighbours so that the nodes of the active contour polyline can freely move around the work zone. A 3-cube neighbourhood of polygon planes around the current one is gathered. Links are created to those polygons that are node or edge connected to the current one.

Each local horizon also stores the projected point cloud points for the active contour to lock onto. The horizon of projected points is built as follows.
1. Gather parts of the work zone's point cloud that project into their individual plane projected polygon. The plane projected polygon may be exploded by about 20% to avoid dead zone projection issues observed at the crest of hills.
2. Use each polygon plane's search horizon to determine a union set of points within the neighbourhood. It is possible there may be quite a lot of points associated with each horizon. The number of points in the horizon is decimated to ensure that the active contour drive towards the point cloud boundary is fast.
3. The samples are decimated by iteratively sieving with a sequence of regular grid filters (fine to coarse) until there are about 40 unique points. The bounding box of the horizon's points (projected onto the central polygon plane) is required for each regular grid. The maximum of the 2-dimensional bounds is used to create a centred square grid located over the horizon area. The grid resolution ranges from 16 to 4 intervals in each direction.
4. The positions of the points are accumulated and averaged within each bin of the regular grid. The points to sieve are passed from the output of the previous level to the input of the next until there are fewer than the target number.

### 4.2.1.5 Identify Narrow Bridges in the Work Zone

The boundary of the point cloud must be determined in a different way for these polygons to prevent trimming polyline interaction and unintentional erosion. The active contour polyline is disabled for edges connected to bridge polygons. A polygon in the work zone is labelled as a bridge type if: all of its neighbouring polygons either touch the outer contour (forms a single polygon strip), or it is part of a two-adjacent work zone configuration whose polygons are connected to the outer contour and have opposing inward vectors (2-polygon side by side strip).

### 4.2.2 Active Contours

The active contour polyline is a 3D polyline that rides over the work zone surface in the inward direction towards the boundary of the point cloud. The algorithm ensures that the polyline is always contained within the work zone with its nodes projected onto the surface. The polyline successfully traverses both flat and curved regions of the mesh by iteratively smoothing the active polyline and driving it towards the boundary of the point cloud.

It is an iterative technique that progressively increases the fraction that the active contour moves towards the point cloud boundary. Only 5 iterations are required to refine the contour to the boundary shape.

### 4.2.2.1 Compute a Smoothed Version of the Active Polyline

For each polyline node get its previous and next nodes. In the general case the smoothed node position is moved to the mid-point of the line formed between the previous-current edge midpoint and the current-next edge midpoint. The endpoints remain fixed for open polylines that do not form a complete loop. The number of polyline nodes remains the same after the smoothing operation.

### 4.2.2.2 Constrain the Polyline to the Work Zone

The nodes of the active contour polyline must lie within the work zone at all times. In the general case the polyline node moves between polygon planes of the work zone. The horizon of polygon planes associated with the node at its last valid position is used to search for its current position.

The smoothing step can also pull the active contour polyline outside of the mesh itself especially in concave regions. In such circumstances a step is performed to backtrack the movement of a polyline node until it lies within the work zone again. The horizon of polygon planes is searched until the line intersects an edge of its plane polygon.

### 4.2.2.3 Drive the Active Contours Towards the Boundary of the Point Cloud

Each active contour edge moves independently.

The inward distances to the point cloud boundary are estimated from both of the edge's endpoints. Different inward distances at the edge endpoints allow the active edge to turn towards the point cloud boundary.

The active contour nodes separate when determining the boundary.

The node positions are averaged later to recover a connected polyline.

### 4.2.2.4 Active Contour Edge Basis Frames

The polyline edge's inward vector is determined from the cross product of the polygon plane normal and edge direction. The edge's inward vector is transformed into the frame of the polygon plane (on 2D plane) and conditioned to lie on the same side as the polygon plane's inward vector.

A frame is created at each endpoint of the active edge to probe the horizon's point cloud samples (inward vector, projected node position and complement direction).

### 4.2.2.5 Estimate the Boundary of the Point Cloud

The horizon of point cloud samples is transformed into the frame of the active edge endpoint. The near and far distances of samples along the edge's inward vector are computed.

The point cloud boundary is computed by finding the distance from the far baseline that accounts for 90% of included points. A binary search strategy is used to bracket the threshold distance that gives the appropriate number of included points. See FIG. 27, which illustrates the point cloud boundary estimation.

The drive target point for the active edge's endpoint is then easily determined from the boundary distance.

In one embodiment a caching mechanism is used to prevent too much re-computation of the point cloud boundary whenever the active edge does not move too much.

### 4.2.2.6 Constrain the Target to the Work Zone

The target can be pulled outside of the mesh itself, especially in concave regions. In such circumstances a step is performed to backtrack the movement between target and current node position until it lies within the work zone again. The horizon of polygon planes is searched until the line intersects an edge of its plane polygon.

### 4.2.2.7 Fractional Move Towards the Point Cloud Boundary

At the start of the procedure the active contour polyline has edges that are aligned with the faces of the grid cubes. The first stages of the algorithm are biased towards polyline smoothing to remove the serrations seen in the outer contour. This quickly aligns the polyline edges with the point cloud boundary. It makes sense to increase the fraction the contour drives towards the boundary target as the number of iterations increase.

### 4.2.2.8 Management of the Active Edge Lengths

Short active contour edges tend to crumple and turn too sharply whenever the polyline is forcibly constrained to the work zone boundary. A minimum edge length constraint is employed to prevent serious issues like this. At the end of each iteration any short edges are removed, with those edges connected to it having their endpoints moved to the removed edge's mid-point.

### 4.2.3 Cut the Polygons with the Trimming Polylines

### 4.2.3.1 Build the Trimming Polylines

Extend open polylines to the work zone edges to ensure that the outside area of the trimmed surface is removed correctly.

Any polygon in the work zone should only be trimmed by a single polyline. The part of this trimming polyline that resides in the neighbourhood can be generated in three steps.
1. First build a map of cube local cutting polyline edges. Each edge connected to a polyline node (there are usually 2) is added to the nearby grid cubes. The nearby cubes are determined by intersecting a small cube centred on the polyline node with its neighbouring grid cubes.
2. For every polygon in the work zone, gather all local cutting edges within a 3 grid cube window. There may be many cutting edge parts within this window. In cases where there are edge parts from more than 1 polyline, choose the trimming polyline that is closest to the polygon centre and filter out the rest.
3. Assemble the filtered edge parts into continuous edge runs. There may still be 1 or more edge runs from the same polyline, but each edge run starts and ends outside the polygon to be trimmed.

### 4.2.3.2 Intersect the Polygon Edges with the Local Cutting Polylines

Iterate over the edges of polygons in the work zone. Gather any cutting polylines from either polygon connected to the edge and determine the points where the trimming lines pass over the edge. Each polygon edge has an associated basis frame that is used as a common space to perform intersection tests.

The candidate cutting points are stored in the edge data. Close candidate edge intersections are then merged.

Nodes are then added into the polygons that connect to the edge.

### 4.2.3.3 Build the ‘Trimming Edge’ Polyline

This stage orders the newly added intersections with the polygon edges along the trimming polyline. This synchronization makes it easy to replace parts of the polygon's edge sequence.
1. Add all the polygon edge intersections into the trimming edge polyline.
2. Condition the ‘trimming edge’ polyline to snap endpoints to the newly added intersections.
3. Synchronize this endpoint intersection information between trimming edge segments. Remove any endpoint intersections from the trimming edge's internal intersections.
4. Tag the trimming edge endpoints as either laying inside or outside the projected plane polygon.

Traverse the ‘trimming edge’ polyline based on its endpoint Tags to build the edges of the polygon that need replacing:
1. Out_to_Out: creates a line segment only if there are 2 interior intersections.
2. In_to_Out: creates a line segment between the trimming edge A endpoint and the 1 interior intersection.
3. Out_to_In: creates a line segment between the 1 interior intersection and the trimming edge B endpoint.
4. In_to_In: creates a line segment between the trimming edge A and B endpoints.

Convert the line segments back to a polyline format that has no duplicate nodes. The vertical positions of any points that are added into the interior of the polygon are interpolated in the plane normal direction between new polygon edge points.

### 4.2.3.4 Split the Polygon with the Trimming Polyline

This stage splits the polygon into two parts by finding where the trimming polyline crosses the contour. The inside part of the polygon containing the point cloud is combined with the part of the trimming polyline that crosses the polygon between entry and exit points.
1. Determine the two nodes where the trimming polyline enters and exists the polygon.
2. Gather the two contour polylines of the polygon between these nodes (forwards and backwards paths between the nodes). Project the two contour polylines and the trimming polyline onto the polygon plane.
3. Find the centre of the local polygon plane point cloud. Use the ‘polygon point cloud centre’ to ‘polyline mid-edge’ vector as an immediate measure of the outward direction. This unit vector is averaged with the polygon's precomputed outward vector from the work zone stage to determine a ray-probe direction.
4. Ray cast from each trimming polyline mid-edge in the current outward ray-probe direction. Determine the signed distances to any hit edges on the forward and backward polygon contour polylines. Determine the average distance to the forward and backward polygon contour polyline.
5. Remove the nodes of the polygon contour polyline with the largest outward average distance and insert the nodes of the trimming polyline in its place. What remains is that part of the polygon that is on the inside of the point cloud boundary.
6. If the trimming polyline touches the inside polyline between the entry and exit nodes then you get repeated nodes. These cause local loops which must be separated into individual polygons.

### 4.3 Computing Break Lines

### 4.3.1 Introduction

The intersection of two distinct smooth surfaces defines a line which is called here a break line. Note that the smooth surfaces are not necessarily planes and therefore break lines are not in general straight lines.

The previous work flow stages have:
1. Superimposed a 3D regular grid of cubes over the region of space occupied by the point cloud
and
2. Replaced the point cloud points by a smoothed mesh consisting of planar polygons.

Each polygon resides within a single grid cube, called the polygon's primary cube. The mesh is called smoothed because each polygon has been fitted through the point cloud points contained in the 27 grid cubes centred on the polygon's primary cube. As a result the mesh gives an excellent fit to smooth surfaces such as planes, pipes or cones. However a much less satisfactory fit is obtained at break lines, for example on stairs, or at the corners of buildings. The purpose of the break line calculation is to improve the fit at such locations by identifying the intersection between the multiple surfaces and modelling the surfaces separately.

### 4.3.2 Surface Trihedrons

Let pᵢ∈ [symbol] ³ be the position of a mesh node. A mesh node pₐ∈ [symbol] ³ is said to be adjacent to pᵢ if the two nodes are consecutive vertexes of a mesh polygon. Let [symbol] ᵢ be the set of all mesh nodes that are adjacent to pᵢ. The covariance matrix at pᵢ is defined as:

$${W}_{i} = {\sum }_{a ∈ {𝒜}_{i}} ( {p}_{a} - {p}_{i} ) {( {p}_{a} - {p}_{i} )}^{T} .$$

A surface trihedron consisting of three orthonormal vectors uᵢ, vᵢ, wᵢ∈ [symbol] ³ is computed at each node pᵢ. The vector wᵢ is computed as the unit eigenvector that corresponds to the smallest eigenvalue of wᵢ. The other two vectors uᵢ and vᵢ are the remaining two eigenvectors of Wᵢ.

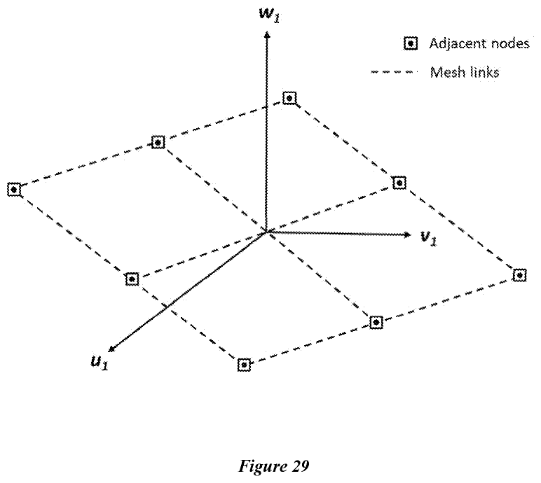

If we treat the mesh nodes as lying in a smooth (that is, continuously differentiable) surface, then wᵢ can be interpreted as the surface normal at pᵢ and the other two vectors uᵢ and vᵢ form a basis of the tangent plane to the surface at pᵢ. See FIG. 29.

### 4.3.3 Connected Node Sets

The set [symbol] ᵢ of nodes pₐ that that are adjacent to pᵢ is also called the depth 1 set of nodes connected to pᵢ and is written [symbol] ᵢ⁽¹⁾. More generally, [symbol] ᵢ^{(r)}, the depth r set of nodes connected to pᵢ, is the set of nodes that belong to [symbol] ᵢ^{(r-1)} or are adjacent to any node in [symbol] ᵢ^{(r-1)}.

### 4.3.4 Surface Contour Lines

Each mesh polygon's vertexes lie on the edges of its primary cube, and the polygon's edges lie across the cube's faces. Therefore all the polygon edges are parallel to one or other of the cardinal planes, and therefore are orthogonal to one or two of the coordinate axes. All polygon edges that are orthogonal to the X axis are called “X edges”, all polygon edges orthogonal to the Y axis are “Y edges”, and all polygon edges that are orthogonal to the Z axis are “Z edges”. Note a polygon edge that lies along a grid cube edge will be simultaneously orthogonal to two of the coordinate axes.

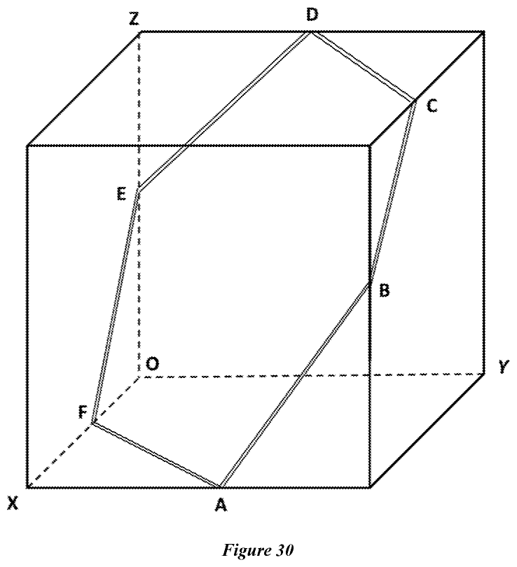

In FIG. 30, the cube edges OX, OY and OZ are parallel to the co-ordinate axes and ABCDEF is the mesh polygon (in this case a hexagon) formed by the intersection of the fitted plane and the cube. Edges AB and DE are X edges. Edges BC and EF are Y edges. Edges CD and FA are Z edges.

“X polylines” are polylines consisting entirely of X edges. “Y polylines” and “Z polylines” are defined analogously. They are surface contour lines corresponding to constant X, Y and Z values.

Note that a node will always lie on at least two contour lines, and sometimes on three such lines.

### 4.3.5 Normal Curvature Estimates

If the pᵢ∈ [symbol] ³ is adjacent along X edges to two other nodes pₐ∈ [symbol] ³ and p_{b}∈ [symbol] ³, then the normal curvature at pᵢ (in the plane through pᵢ that is orthogonal to the X-axis) is computed by the formula κ_{X}=r^{T}wᵢ/r^{T}r where wᵢ∈ [symbol] ³ is the unit surface normal at pᵢ and r=p₀−pᵢ, where p₀∈ [symbol] ³ is the position of the centre of the circle fitted through the three nodes pₐ, p_{b}, pᵢ.

If pᵢ is adjacent along an X edge to only one node pₐ, then the normal curvature is computed by the formula κ_{X}=2 (pₐ−pᵢ)^{T}wᵢ/(pₐ−pᵢ)^{T}(pₐ−pᵢ).

The normal curvatures Ky and Kz are computed analogously.

A node will always have at least two normal curvatures.

### 4.3.6 Estimation of the Curvature Tensor

The curvature tensor at pᵢ is estimated as follows. Let uᵢ, vᵢ, wᵢ be the surface trihedron at pᵢ. Every node pₖ∈ [symbol] ⁽³⁾ in the depth 3 set of nodes connected to pᵢ, can be written as

$${p}_{k} = {p}_{i} + {x}_{k} {u}_{i} + {y}_{k} {v}_{i} + {z}_{k} {w}_{i}$$

where xₖ=Δpₖ^{T}uₖ, yₖ=pₖ^{T}vₖ, zₖ=Δpₖ^{T}wₖ, and where Δpₖ=pₖ−p₀. Compute the unit vector:

$$( {\hat{x}}_{k} , {\hat{y}}_{k} ) = \frac{1}{\sqrt{{x}_{k}^{2} + {y}_{k}^{2}}} ( {x}_{k} , {y}_{k} )$$

This corresponds to a unit vector in the tangent plane. Compute the curvature associated with this direction as

$${c}_{k} = 2 \frac{Δ {p}_{k}^{T} {w}_{0}}{Δ {p}_{k}^{T} Δ {p}_{k}} .$$

More generally, if the curvature tensor has coefficients

$$C = ( \begin{matrix}{a}_{0} & {a}_{1} \\ {a}_{1} & {a}_{2}\end{matrix} )$$

in this coordinate system, then the normal curvature along the unit direction (\hat{x}, ŷ) is given by:

$$c ( \hat{x} , \hat{y} ) = {a}_{0} {\hat{x}}^{2} + 2 {a}_{1} \hat{x} \hat{y} + {a}_{2} {\hat{y}}^{2} .$$

It is natural to compute these coefficients by linear least squares. That is we minimize

$$V = {[ {\sum }_{k} ( c ( {\hat{x}}_{k} , {\hat{y}}_{k} ) - {c}_{k} ) ]}^{2} = {[ {\sum }_{k} ( {a}_{0} {\hat{x}}_{k}^{2} + 2 {a}_{1} {\hat{x}}_{k} {\hat{y}}_{k} + {a}_{2} {\hat{y}}_{k}^{2} - {c}_{k} ) ]}^{2} .$$

### 4.3.7 High Curvature Nodes

The first step of the break line calculation is to locate nodes with high surface curvature. Break lines are likely to occur close to such nodes.

Because the calculation of the curvature tensor is relatively expensive, the normal curvatures are first estimated using the appropriate formulae of Section 4.3.5. If the absolute values of any of the normal curvatures is greater than the tolerance κ_{TOL}, then the curvature tensor [symbol] is computed as explained in Section 4.3.6. The node pᵢ is considered to have high curvature if either of the absolute values of the eigenvalues of the curvature tensor [symbol] are greater than κ_{TOL}.

The curvature value of every high curvature node is stored in a high curvature node table. The table contains a separate curvature value for each contour that passes through the node and the links associated with that curvature. Such links are called high curvature links.

A suitable choice for the numerical value of curvature tolerance κ_{TOL} is essential. If κ_{TOL} is set too high then subsequent steps in the break line calculation may create break lines where none exist. Similarly, giving κ_{TOL} too small a value will cause some break lines to remain unrecognized.

A good compromise is obtained by setting κ_{TOL}=2/9 h where h is the size of the grid cubes (the resolution).

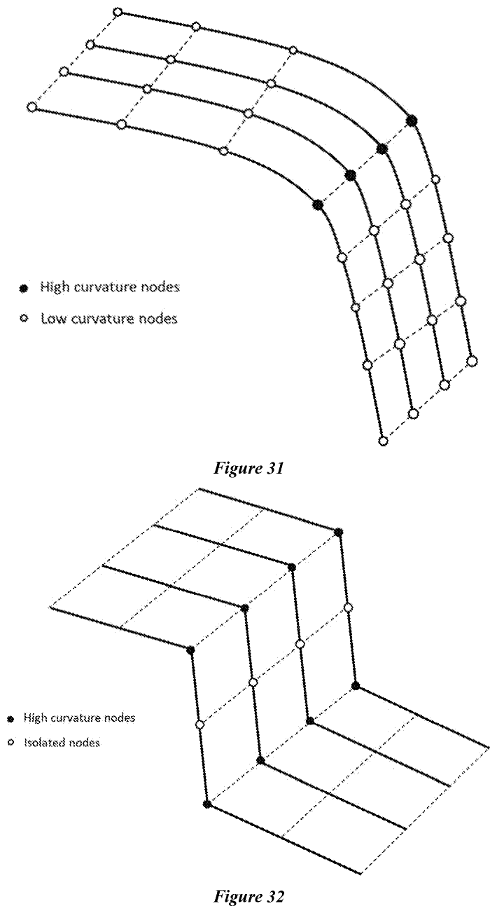

FIG. 31 shows a typical situation in which high curvature nodes occur. The solid lines are X edges and the nodes along these edges are either black (high curvature nodes) or white (low curvature nodes). Notice that in this example the high curvature nodes are low curvature nodes when considered along the Y edges (dashed lines).

### 4.3.8 Isolated Nodes

Isolated nodes are defined as nodes that do not themselves have high curvature, but are connected on both sides along a contour by high curvature nodes. The isolated nodes are added to the high curvature node set, together with the links that connect them to high curvature nodes. See FIG. 32.

### 4.3.9 Sign of Curvature

Consider a contour line passing in order through three adjacent nodes p₀, p₁ and p₂ on a surface. Let

$$\{ \begin{matrix}u = {p}_{1} - {p}_{0} \\ v = {p}_{2} - {p}_{1}\end{matrix}$$

and let û and \hat{v} be the corresponding unit vectors. Compute the vector product

$$w = \hat{u} \times \hat{v} .$$

In detail, let û=(uₓ, u_{y}, u_{z}), \hat{v}=(uₓ, v_{y}, u_{z}) and w=(wₓ, w_{y}, w_{z}). Then

$$\{ \begin{matrix}{w}_{x} = {u}_{y} {v}_{z} - {u}_{z} {v}_{y} \\ {w}_{y} = {u}_{z} {v}_{x} - {u}_{x} {v}_{z} \\ {w}_{z} = {u}_{x} {v}_{y} - {u}_{y} {v}_{x}\end{matrix} .$$

But û and \hat{v} lie along the same contour line and therefore either are both X edges, both Y edges or both Z edges. If they are both X edges, then their x-components uₖ and u_{y} are both zero, in which case both w_{y} and w_{z} are zero, and the sign of the curvature at p₁ is defined as the sign of wₓ. Similarly if û and \hat{v} are both Y edges then wₓ and w_{z} are both zero and the sign of the curvature at p₁ is defined as the sign of w_{y}. And if û and \hat{v} are both Z edges then the sign of the curvature at p₁ is defined as the sign of w_{z}. Notice that the sign of curvature, calculated in this way, does not depend on the orientation of the surface normal.

The sign of curvature is calculated for every high curvature node (including isolated nodes). A separate sign of curvature is computed for each contour passing through the node.

If the node is a point of inflection along a contour (that is if along the contour the curvature has different signs on either side of the node) then the curvature value corresponding to that contour is removed from the high node curvature table entry for that node.

### 4.3.10 Boundary Nodes

Boundary nodes are low curvature nodes that:
1. Are adjacent to high curvature nodes along high curvature links and
2. At which the curvature does not change sign.

Boundary nodes are added to the high curvature table, together with their high curvature links.

A double boundary node is one that is adjacent to another boundary node along a high curvature link. Double boundary nodes are removed from the high curvature table, together with the link connecting them.

The surface normals at all double boundary points are recalculated so that they are orthogonal to the line joining them. In detail, let pₐ, p_{b}∈ [symbol] ³ be a pair of boundary nodes and let their corresponding surface normals be wₐ and w_{b}. Then these surface normals are recomputed to become

$$\{ \begin{matrix}{w}_{a}^{′} = {w}_{a} + {α}_{a} u \\ {w}_{b}^{′} = {w}_{b} + {α}_{b} u\end{matrix}$$

where u=p_{b}−pₐ and αₐ=−u^{T}wₐ/u^{T}u and α_{b}=−u^{T}w_{b}/u^{T}u.

### 4.3.11 Previous Node Table

An edge link is a mesh link that belongs to only one polygon. An edge node is a node that belongs to an edge link.

The previous node table is used to trace a chain of nodes along a contour. It associates each node in the chain with its predecessor nodes along the contour. Because there are three possible contours through each node, the previous node table may associate nodes with three different previous nodes.

A root node is a low curvature node that is adjacent to a boundary node along a contour. The previous node table is seeded by allocating storage space (but initially without associated previous nodes) for all root nodes, double boundary nodes and curvature change nodes (nodes at which the curvature changes sign, that is the nodes on opposite sides along the contour have different signs). Exception: any nodes that are also edge nodes are not added to the previous node table.

The previous node table is grown by the following process. Identify all high curvature nodes that are both not in the table and adjacent, along high curvature links, to nodes that are already in the table. Once all of the adjacent nodes have been identified, each adjacent node is added to the previous node table in two places. In detail, suppose node A is already in the table and node B is an adjacent node that has high curvature along the link joining A and B. Then:
1. The adjacent node B is added to the table as a predecessor node of the existing node A
and
2. A new entry is added to the table for node B with node A indicated as its predecessor.

This process is repeated until no further suitable adjacent nodes remain.

### 4.3.12 Chain Root Node Table

The previous node table implicitly defines chains of consecutive nodes along a contour. Apart from the two end nodes of the chain, each chain node has two predecessor nodes. The two end nodes, having only one processor node, are readily identified as root nodes. The chain root table lists the root node pairs associated with each chain node. There is one root pair for each chain that the chain node belongs to. The chain root table is compiled as follows. Starting at a chain node, which by definition has two predecessor nodes, the chain is traced in both directions until the two root nodes are reached at the end.

Each chain lies along a contour and therefore in a plane orthogonal to one of the coordinate axes. The surface normal at a root node is called skew if it is nearly orthogonal to the coordinate axis. More precisely, the root node is skew if êᵣ^{T}ŵₐ>0.9, where êᵣ∈ [symbol] ³ is the direction of the coordinate axis orthogonal to the chain and ŵₐ∈ [symbol] ³ is the surface normal at the root node.

If both root nodes are skew, the root nodes and all the chain nodes between them are removed from the chain root node table.

If only one root node is skew, an attempt to find a better replacement root node pair and chain is made as follows. Suppose that the current chain nodes listed in order along the chain are a, c₀, c₁, c₂, . . . , cₙ, b where a and b are the root nodes and a is skew. If one of the chain nodes c, also belongs to another chain, then the current chain is shortened to become cᵣ, . . . , b and the root nodes of the chain become cᵣ and b. The chain root node table is updated accordingly. If more than one of the current chain nodes also belongs to another chain, then the one nearest to b (along the chain) is used to replace a.

### 4.3.13 Analysing Node Chains

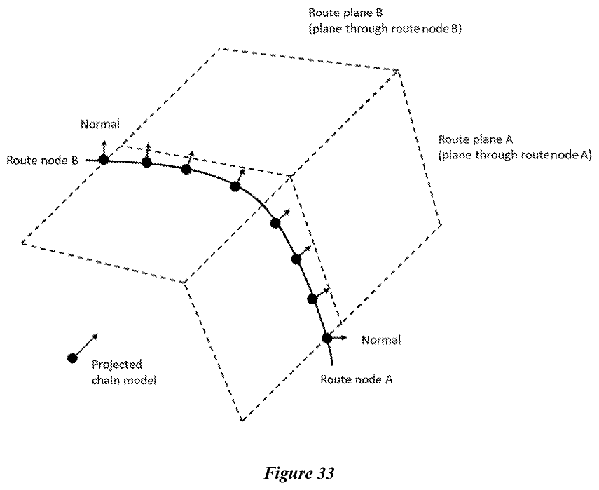

The position and surface normal of each root node define a plane through that root node. Each chain has two root nodes and therefore has two associated root planes. The key idea of the break line calculation is to move each chain node (each node between the two root nodes) by projecting it onto the nearest of the two root planes. The surface normals at each moved chain node is also changed to equal the normal of the corresponding root plane. See FIG. 33.

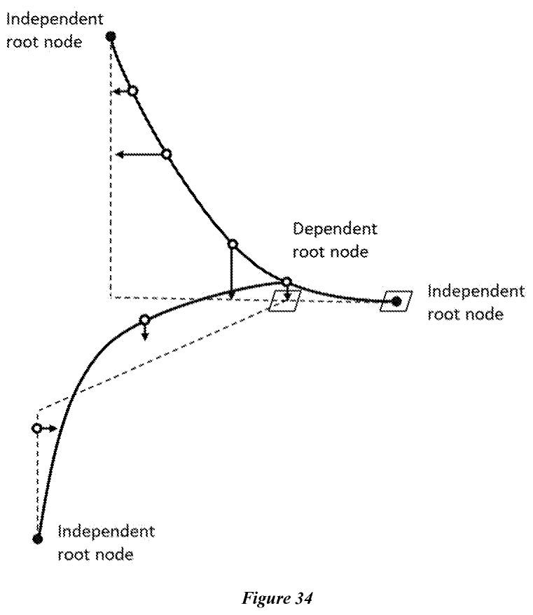

Now consider two chains A and B. Suppose that node R is a root node of chain A and is a chain node (not a root node) of chain B. Then node R is called a dependent root node. Its position and surface normal (and therefore its plane) will be projected onto the nearest of two root nodes of chain B. It is essential that the projection of node R occurs before R is used as a root node, so that the resulting chain node positions are consistent. To ensure this, chain nodes are only projected if both their root nodes are not dependent. If any of the newly projected chain nodes are root nodes of another chain, these root nodes (which by definition are dependent) are flagged as having been resolved. Once both root nodes of a chain are either not dependent or have been resolved, the chain nodes can be projected onto the nearest root plane. See FIG. 34.

### 4.3.14 Break Links and Break Nodes

Once the chain nodes have been projected, every chain node lies in one of the two root planes. A break link is any link in the chain whose ends do not both lie in the same root plane. If there is only one break link chain (which is usually the case) a break node is inserted in the break link, splitting it into two links. The two end nodes of the link being broken are called side nodes. The break node is positioned at the intersection of the two root planes. (Exception: if one of the nodes of the break link is sufficiently close to both root planes, it becomes a break node and is moved to the intersection of the root planes. In this case the break link is not split. In this case one of the side nodes is identical to the break node.)

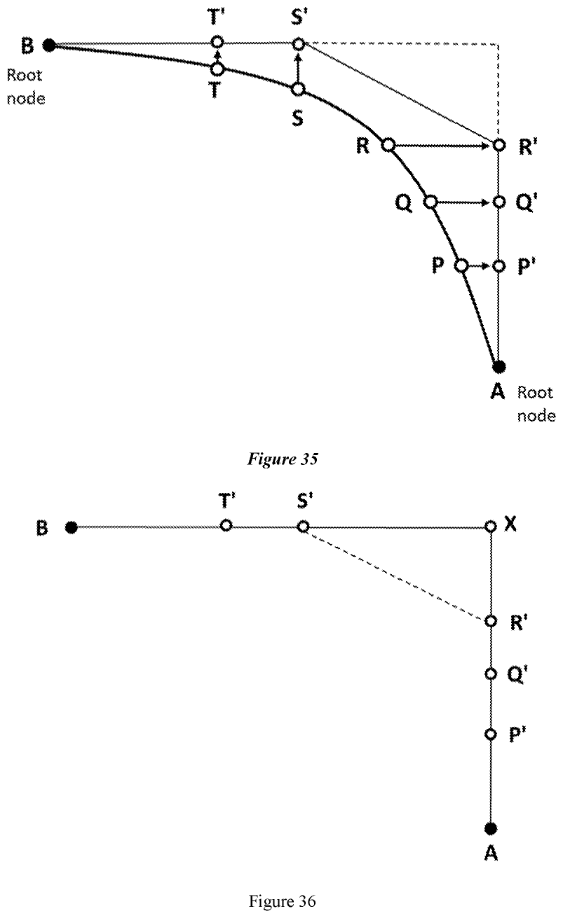

In FIG. 35, A and B are root nodes. P, Q, R, S and T are the original positions of chain nodes, and P′, Q′, R′, S′ and T′ are their projected positions. Nodes P′, Q′ and R′ lie in root plane A and S′ and T′ lie in root plane B. Nodes R′ and S′ are the side nodes and R'S′ is the break link.

FIG. 36 shows the chain after the break node X has been inserted in link R'S′.

### 4.3.15 Affected Nodes

An affected node is a node that is not in a chain but is adjacent to at least two chain nodes that have been moved. Each of these adjacent nodes will have been projected to a root plane. The affected node is projected onto the nearest root plane.

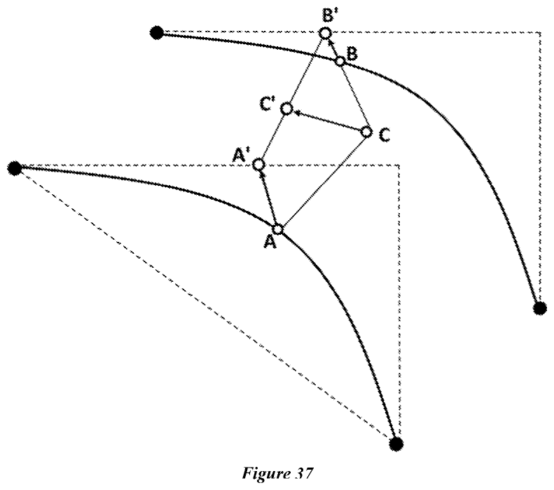

In FIG. 37, A and B are chain nodes on different chains and A′ and B′ are their projected positions. C is a node that is adjacent to A and B, and C′ its projected position.

### 4.3.16 Clone Split Nodes

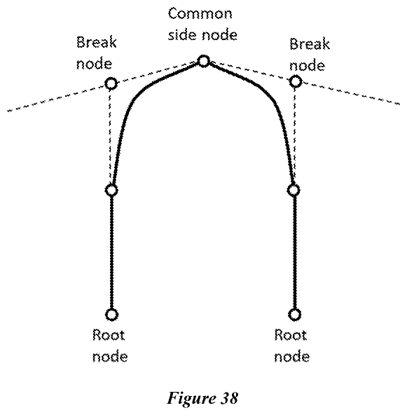

Clone split nodes are break nodes that are sufficiently close to each other (for example within 0.2 times the grid cube size)) and have a common side node. They usually occur at the intersections of three distinct surfaces. (See FIG. 38). Clone split nodes and the links joining them to the common side node are removed from the polygonal mesh. The common side node becomes the break node and is moved to mean of the positions of the two removed split nodes.

### 4.3.17 Binary Nodes

A binary is a node that only has two adjacent nodes. If a binary node is
1. adjacent to two break nodes
and
2. is itself not a break node,
   then the binary node is removed from the mesh.

### 4.3.18 Edge Directions

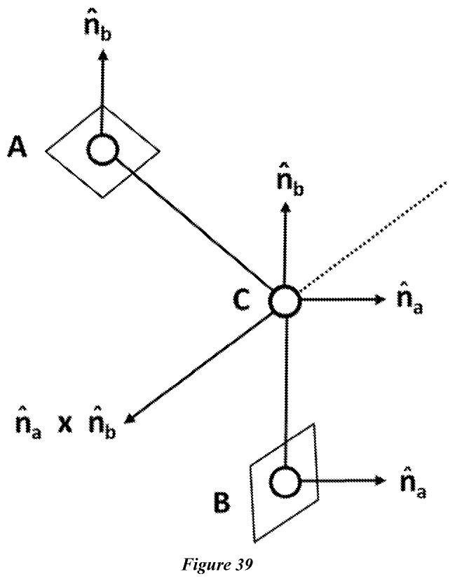

Every break node is associated with the two root planes. The edge direction is the unit normal that is orthogonal to both plane normals. See FIG. 39.

### 4.3.19 Splitting Polygons Containing Two Break Nodes

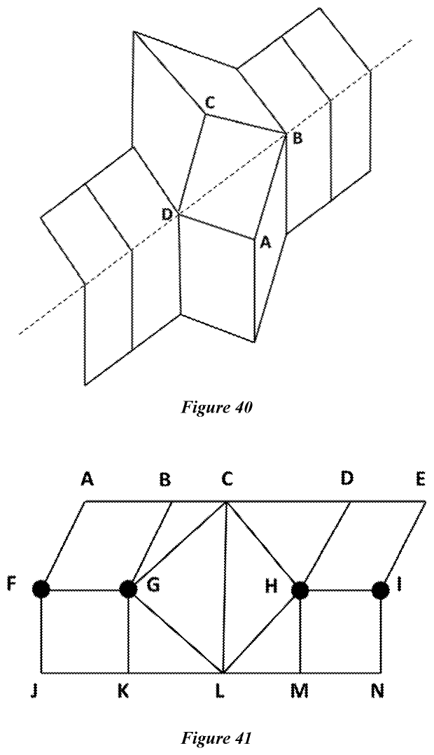

Polygons containing exactly two break nodes are split into two separate polygons along the line joining the two break nodes provided the break nodes are not adjacent and the angle between their edge directions is less than 30 degrees. Note that the two break nodes are contained in both resulting polygons and are adjacent in those polygons. In FIG. 40, ABCD is a polygon where B and D are non-adjacent break nodes. The polygon is split into triangles ABD and BCD.

### 4.3.20 Splitting Break Polygon Pairs

A polygon that contains exactly one break node is called a break polygon. Two break polygons form a break polygon pair if they share at least two nodes but not break nodes. That is, between them, they contain two break nodes.

A break polygon pair is isolated if its two constituent polygons are not members of other break polygon pairs.

For example in FIG. 41, nodes F, G, H and I are break nodes. Polygons ABGF, FGKJ, DEIH and HINM are not break polygons because they each contain two break nodes. Polygons BCG, CDH, GCL, CHL, GLK and HML all contain exactly one break node each and are therefore break polygons. However only GCL and CHL together form an isolated break polygon pair.

An isolated break polygon pair is split by replacing the two constituent polygons by a single combined polygon, and then splitting the combined polygon along the line joining the two break nodes.

Isolated break polygon pairs are split in two passes:
1. The first pass is applied to break polygon pairs whose break nodes are adjacent to a common node (not necessarily the same one);
2. The second pass is applied to break polygon pairs where one of the side nodes of both break nodes is adjacent to a common node.

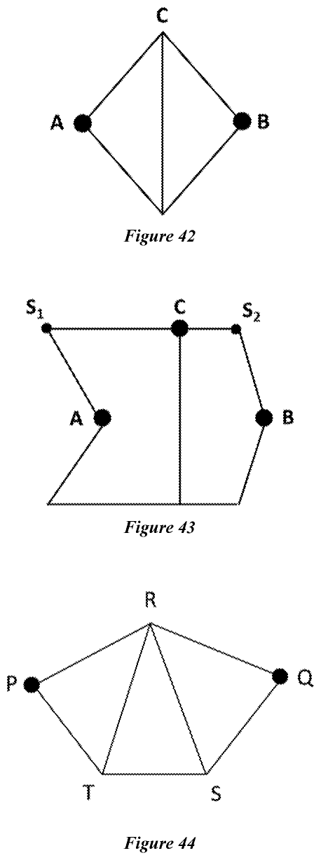

For example in FIG. 42, And B are break nodes and are adjacent to common node C. In FIG. 43, A and B are break nodes and S1 and S2 are side nodes which are both adjacent to the common node C.

In both passes, the polygons are only split if the angle between the two break edges is less than 30 degrees and if the angle between the line joining the two break nodes and each break edge is less than 45 degrees.

### 4.3.21 Splitting Break Polygon Triplets

A break polygon triplet are three polygons A, B and C where:
1. A and C each contain one break node
2. B does not contain a break node
3. B has one common edge with A and C
and
4. A and C have no common nodes.

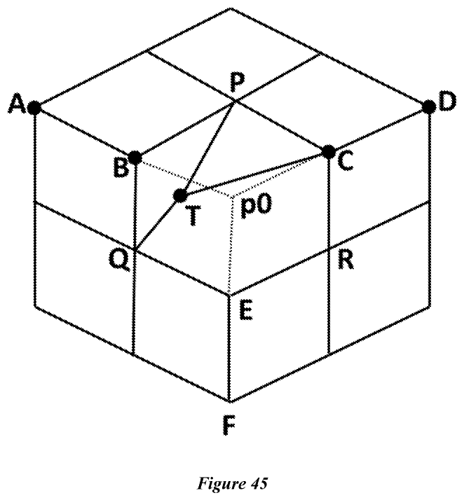

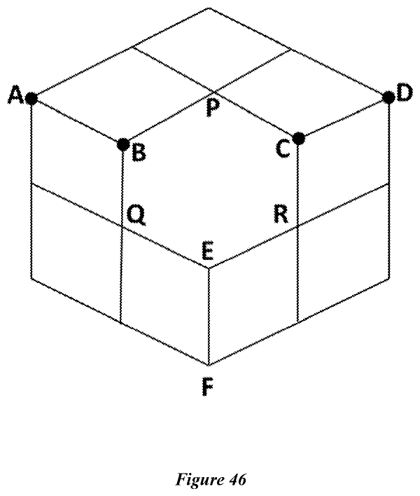

For example in FIG. 44, P and Q are break nodes and polygons PRT, RST and RQS together form a break polygon triplet.

Break polygon triplets are split by joining the three polygons together to form a single composite polygon, and then splitting the composite polygon along the line through its two break nodes.

### 4.3.22 Break Line Graph

In this context a graph is a topological data structure consisting of nodes and links between pairs of nodes. A break line node is a graph in which all the nodes are break nodes.

An end node is a node that belongs to only one link. Since the links represent break lines, end nodes should only occur at locations where the point cloud ends. Otherwise they represent a location where the break line should be extended. One situation in which this can occur is that of triple nodes, where three break lines need to be extended to meet at a corner.

### 4.3.23 Triple Nodes

An end polygon is a polygon that contains one end node of the break line graph, but no other break nodes. A triple node T is a node that is not a break node but belongs to (is a node of) three distinct end polygons. Each of the three end nodes is associated with two root planes, making a theoretical total of six planes in all. However some of these root planes may be identical. If the system of six linear equations corresponding to the root planes has rank 3, then a unique intersection position p₀∈ [symbol] ³ can be computed by linear least squares. If the position of the triple node T is sufficiently close to the intersection position p₀, then:
1. T is moved to p₀
and
2. Each end polygon is split into two separate polygons along the straight line joining p₀ and the polygon's end node.

For example in FIG. 45, nodes A, B, C, D, E and F are break nodes. Nodes B, C and E are end nodes. Polygons TBPC, TCRE and TEQB are end polygons. Node T is a triple node.

### 4.3.24 Corner Polygons

A polygon that contains more than two break nodes is called a corner polygon. Corner polygon clusters are sets of corner polygons that share at least one node (not necessarily a break node) with another corner polygon. However a corner polygon cluster will often contain only one polygon.

In

FIG. 46, nodes A, B, C, D, E and F are break nodes. Polygon PBQERC is a corner polygon and the only member of a corner polygon cluster.

Each individual corner polygon P of a cluster may be adjacent to (share at least two nodes with) a polygon A that:
1. Does not belong to the cluster (so A is not itself a corner polygon);
2. Contains at least one break node;
and
3. This break node does not belong to P nor is it adjacent to any of the break nodes in P.

The set of all such adjacent break node polygons is identified for the cluster. Once the entire set has been identified, it is added to the cluster to form an augmented cluster. Thus only a single layer of adjacent polygons is added, and the cluster does not grow indefinitely.

In FIG. 47, nodes A, B, C, D, E and F are break nodes. Polygon PBQERC is a corner polygon. Polygons APBQ, DRCP and FQER are adjacent break node polygons. The augmented cluster consists of all four polygons.

Next the polygons adjacent to the augmented cluster are investigated. Each edge of such an adjacent polygon is called common if the edge is shared with a polygon of the augmented cluster, and is called separate otherwise. The adjacent polygon is said to be embedded in the cluster if the sum of the lengths of its common edges is greater than the sum of the lengths of its separate edges. The set of all embedded polygons is identified. Once the embedded set has been identified its polygons are added to the augmented cluster to form a set called a nearly convex corner cluster.

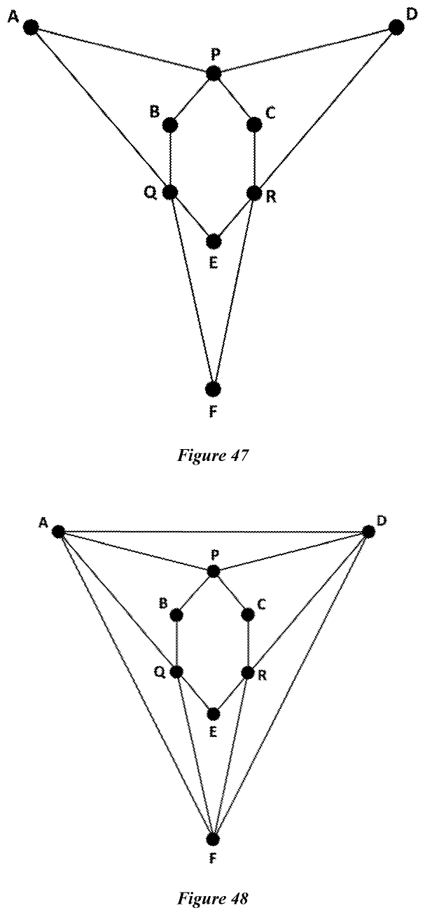

FIG. 48 is an extended version of FIG. 47. The embedded polygons are PAD, QFA and RDF.

By construction, the nearly convex corner cluster will contain at least three break nodes. Each break node will be associated with two root planes, making a theoretical total of six root planes. If the rank of these root planes is three, they are solved by linear least squares to give a unique intersection point. This step is identical to that used in splitting triple nodes.

If the computed intersection point is sufficiently close to at least one of the nodes of the nearly convex corner cluster, then the intersection point is treated as a new break node and all polygons of the convex cluster are replaced by a set of new corner polygons, where each new corner polygon contains the new break node plus two existing break nodes. The two straight line segments joining the new break node to the two existing break nodes are both edges of the new corner polygon. The remaining edges trace a connected path from one existing break node to the other break node.

### 4.4 Building the Triangle Mesh Graph

When this step is applied, the mesh consists of polygons, some of which may be non-planar. Polygons with more than three nodes are split into triangles in such a way as to minimize the sum of the cosines between each triangle normal.

### 4.5 Surface Simplification

At the start of the surface simplification step, the mesh consists of a very large number of triangles, many of which are smaller than a grid cube. Although the mesh is an excellent representation of the point cloud surface being modelled, the mesh requires so much memory to store it, that at least for larger models, computers struggle to handle it. This is particularly so if the mesh is passed to third-party software which may also be using the available memory for other purposes. The surface simplification step therefore attempts to reduce the number of triangles.

In what follows, an edge is called a break edge if:
a. it belongs to two triangles
and
b. the angle between the two triangle face normals is greater than a threshold called the surface angle tolerance (typically set to 22 degrees).

An edge is that is not a break edge is called a smooth edge.

A triangle is called skinny if any of its angles is smaller than a given tolerance. In one embodiment of our method a tolerance of 5 degrees was used.

The surface simplification process consists of the following steps:
2. Remove skinny triangles. If possible, Delaunay triangulation flipping is applied across an edge of the skinny triangle to replace the skinny triangle and its neighbour (which may or may not be itself skinny) by two new non-skinny triangles. Invalid triangles that form a single point or edge are simply removed from the mesh.
3. Identify and remove small area surfaces. For this purpose, surfaces are defined as smooth contiguous sets of triangles. That is, (unless the surface consists of only one triangle) every triangle in a surface shares a smooth edge with another triangle in that surface. The area of this surface is defined as the sum of the areas of its triangles. Surfaces with total areas that are less than a given threshold are called small area surfaces and are removed. The threshold is called the surface area tolerance and is usually set to 0.0025 square metres.
4. Identify break edges
5. Collapse edges to remove triangles from the mesh, as described in Section 4.6.
6. Recompute the break edges.
7. Close the break edge runs. See Section 4.7.
8. Grow surfaces by flood filling. As already explained, surfaces consist of one or more triangles that share a smooth edge (that is a non-break edge). Each triangle is allocated to a surface as follows.
   a. If all triangles have been allocated to a surface then stop.
   b. Otherwise choose any triangle that has not yet been allocated to a surface. Add this triangle to a new set of triangles. This set is called the current surface.
   c. Add all smooth edges of the seed triangle to the set of frontier edges.
   d. For each edge in the frontier set:
      i. Add any connected triangles that haven't yet been assigned to a surface to the current surface.
      ii. Add all smooth edges of any added triangle (excluding the current edge) to the frontier edge set.
      iii. Repeat Step d until there are no more frontier edges to add to the set.
   e. Repeat Step a until there are no more triangles
9. Remove skinny triangles. This step is a repeat of Step 2.
10. If any triangle shares all three edges with another surface, re-allocate the triangle to the surrounding surface.
11. Remove all break edges below a threshold called the ‘definite angle tolerance’ that have the same surface on both sides. A definite angle tolerance of 40 degrees has been found to work well.

### 4.6 Triangle Mesh Simplification

### 4.6.1 Overview

Each distinct triangle mesh is simplified by collapsing certain edges. That is, the two nodes that comprise the edge are replaced by a single node positioned near to the mid-point of the edge. The new node replaces the existing nodes in all the connected edges (the mesh edges that contain one of the nodes being replaced).

Every mesh edge is considered as a possible candidate for edge collapsing. Three properties are computed for each edge for use in the mesh simplification. The three properties are:
1. A 3D vector called the collapse position,
2. A floating point number, called the maximum height from plane, and
3. An integer called the job number.

The collapse position is the location of the single node which would replace the edge if it were collapsed. The ‘maximum height from plane’ is a measure of how far the collapse position is from the planes of the surrounding triangles. (The collapse position and the maximum height from plane are defined in detail below. In particular, in some circumstances the maximum height from plane computation may be deemed invalid.) Because the positions of an edge's end points may change as the mesh simplification progresses, an edge's maximum height from plane and collapse position may be recomputed several times. Each time they are successfully recomputed, the edge's job number is incremented by one.

Edges whose ‘maximum height from plane’ computation is valid and whose maximum height from plane value is less than a given threshold are added to a map of edges to be collapsed. The threshold is called the planar patch fitting tolerance. A suitable value is one fifth of the grid cube size. The map key is the ‘maximum height from the plane’. The other entries are the candidate edge (defined by its end nodes) and the edge's current job number.

Each edge in the map of edges is considered in turn, starting with the edge having smallest maximum height from plane.

If the edge no longer exists in the mesh, or if the job number stored in the map does not equal the edge's job number, the entry is deleted from the map. The latter happens if the edge's maximum height from plane has been recomputed more recently than the current map entry.

Otherwise the edge's maximum height from plane and collapse position are recomputed (because the position of the edge's two nodes may have changed). If the computation is invalid the entry is deleted from the map. If the edge's new maximum height from plane is valid and remains below the planar fitting tolerance, the edge is collapsed and replaced by a node at its collapse position, and the current entry is deleted from the map. The ‘maximum height from plane’ values are recomputed for all the edges connected to the new node. If the recomputed value is valid and is below the planar fitting tolerance, the connected edge is inserted into the map of edges to be collapsed. Note that this means that an edge can occur in more than one place in the map, however the job number identifies the most recent one.

Once an entry in the map has been processed it is deleted from the map. The edge collapse process is continued until the map of edges to be collapsed is empty.

### 4.6.2 Maximum Height from Plane Calculation

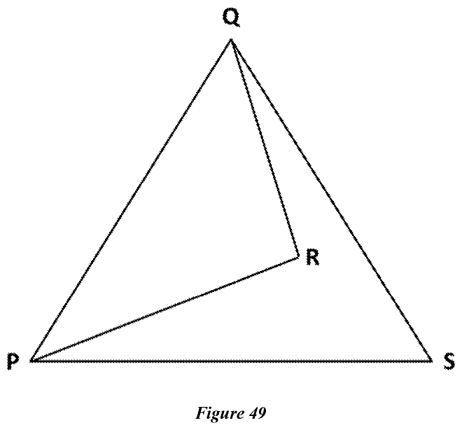

This section explains how the maximum height from plane is computed for an edge AB. As part of the process, the position of the collapse position is also calculated. A mesh triangle is called a connected triangle if its nodes contain at least one of the end nodes A and B. Let the plane of each connected triangle Δₖ be written as aₖX=βₖ, where aₖ is the plane unit normal, βₖ is the plane scalar constant, and the suffix k is an integer identifying the triangle. Let [symbol] be the set of identifiers of all triangles connected to AB. Let [symbol] be the identifiers of all triangles connected to edge AB that contain only one of the end nodes A and B. Note that [symbol] is a subset of [symbol] . For each triangle Δᵣ in [symbol] , compute a shape position pᵣ∈ [symbol] ³ as follows. Suppose that triangle Δᵣ has nodes P, Q and R, where R is one of A and B. Form the equilateral triangle PQS where the new node S lies on the same side of PQ as R. The shape position is given by the location of S. See FIG. 49. The shape position is a candidate for the collapse position because the edge collapse would cause the particular triangle Δᵣ to become equilateral.

An edge of a triangle is called connected if it shares one or two nodes with AB. If one of a connected triangle's edges is AB, then all three of its edges are connected. Otherwise the triangle has two connected edges.

A push down list of planes is constructed as follows. The individual entries of the push down list are stored as pairs (aₖ, βₖ). Each connected triangle is visited in turn. The connected triangle's plane is pushed once for each of the triangle's connected edges that is also a break edge or a boundary edge (an edge that belongs to only one triangle of the surface). Note that the push down list will often contain the same plane more than one. This is because:
1. A triangle edge may belong to two connected triangles
and
2. A connected triangle may possess more than one edge that is a break edge or a boundary edge.

A second push-down list of planes is also constructed. The planes in the list are called end stop planes. Each connected triangle is considered in turn. Within each connected triangle, each edge is considered in turn. If the edge is connected to AB (that is, at least one of the edge's nodes are A or B) and if the edge is a break edge or a boundary edge (an edge that belongs to only one triangle) then the triangle plane is pushed onto the list of end stop planes. The purpose of the end stop planes list is to prevent a break edge or boundary edge being moved (at least not far) if the edge is collapsed.

The collapse position x∈ [symbol] ³ is computed so as to minimize the sum of squares

$$V = {\sum }_{k ∈ 𝒞} {[ {a}_{k}^{T} x - {β}_{k} ]}^{2} + {\sum }_{r} {[ {a}_{k ( r )}^{T} x - {β}_{k ( r )} ]}^{2} + w [ {( x - m )}^{T} ( x - m ) + {\sum }_{s ∈ 𝒜} {( x - {p}_{s} )}^{T} ( x - {p}_{s} ) ]$$

where in the second summation on the right is over all entries in the push down list of end stop planes, k(r) is the identifier of the rth entry in the list, m∈ [symbol] ³ is the mid-point of the nodes A and B, and w∈ [symbol] is a weighting factor. In one embodiment of the invention the weighting factor is set to 0.01. The collapse position balances the conflicting requirements that it lies close to:
1. The planes of the connected triangles
2. The planes of end stop triangles
3. The mid-point m
and
4. The shape positions pₛ . . .

In one embodiment, the minimum of the objective function V is given by the solution of the linear equation Ax=b, where the matrix A∈ [symbol] ^{3×3} and the vector b∈ [symbol] ³ are computed as

$$\{ \begin{matrix}A = {\sum }_{k ∈ 𝒞} {a}_{k} {a}_{k}^{T} + {\sum }_{r} {a}_{k ( r )} {a}_{k ( r )}^{T} + w ( n + 1 ) I \\ b = {\sum }_{k ∈ 𝒞} {β}_{k} {a}_{k} + {\sum }_{r} {β}_{k ( r )} {a}_{k ( r )} + w ( m + {\sum }_{s ∈ 𝒜} {p}_{s} )\end{matrix}$$

where n is the number of entries in [symbol] . If A is not of full rank. the maximum height from plane computation is flagged as invalid.

To prevent the edge collapse from moving connected triangles on top of each other, the maximum height from plane computation is flagged as invalid if the collapse position does not lie on the same side of the base of each connected triangle as that triangle's shape position.

The maximum height from plane is the maximum distance of the collapse position from the planes of all the connected triangles.

### 4.7 Close Break Edge Runs

Break edge runs are consecutive break (or boundary) edges. They stop at open edges or forks. An open (ended) edge is one that is not connected to any other break (or boundary) edge. The seed triangles are triangles that contain an open edge. (By construction each seed triangle can only contain one open edge). Each open edge therefore has two seed triangles.

Each seed triangle is grown into a nearly planar surface. The surface consists of a contiguous set of triangles. The triangles are contiguous in the sense that each triangle in the set shares an edge with another triangle in the set (unless the set consists of only one triangle.) The planar surface is grown using a push down list of edges. Edges are pushed onto the list and then popped (removed) after they have been inspected. The nodes of every triangle within the nearly planar surface lie within a tolerance of the seed plane (the plane of the seed triangle).

The growing process is as follows:
1. Initialize:
   a. The planar surface to include the seed triangle
   and
   b. The frontier set to include the two edges of the seed triangle that are not break or boundary edges.
2. Pop the last edge from the list of frontier edges. Identify the two triangles in the mesh that contain that edge. One of the triangles will already be in the nearly planar surface. The other triangle is a candidate for being added to the nearly planar set. It is added if all the following conditions hold:
   a. It is not already in the nearly planar surface
   b. All the nodes of the candidate triangle are within a threshold distance of seed plane and
   c. None of the edges of the candidate triangle are break or boundary edges.
If the candidate triangle is added to the nearly planar surface, then the triangle's edges are added to the frontier set.

Step 2 is repeated until the frontier set is empty.

By construction, the nearly planar surface only contains one break or boundary edge. This is the seed edge, the open edge that forms one edge of the seed triangle. The nearly planar surface has its own border edges, that is edges that belong to only one of the triangles in the nearly planar surface. One of these is the seed edge. The border edges of the nearly planar surface are any edges that belong to only one triangle of the surface. (The term border is used to distinguish it from boundary edges of the mesh.) Border edges are traced from each open end of the seed edge, to construct a contiguous chain of border edges, until the chain reaches an end node of another break edge run. Because this chain of border edges may have branches, it is necessary to trace all possible edges, forming a tree of border edges. Note that each as end node has two trees, one for each seed triangle. Both the root node and the leaf nodes of the tree are end nodes. Each root node and leaf node are connected by a contiguous sequence of border edges, none of which are break or boundary edges. The distance between every root node and leaf node pair is the sum of the length of the chain of border edges. The end node pair with shortest distance is connected by adding every border node in their chain to the set of break edges.

### 4.8 Surface Texturing

### 4.8.1 Overview of Surface Texturing

Surface texturing is concerned with colouring the surfaces of the mesh surface to inform the point cloud being modelled. Note that here colouring includes RGB and intensity data that may be stored for each point in the point cloud. It may also include derived point information such as the distance of point from the mesh.

The colour information is constructed as a 2D surface called a texture. As well as its (x,y,z) 3D position coordinates, each vertex in the mesh has 2D (u, v) texture coordinates. There is one pair of texture coordinates for each mesh triangle that the vertex belongs to. The texture coordinates define the vertex's position within a bitmap. The colour, intensity or other texture value of any point on the surface of the mesh triangle is computed by linear interpolation in the bitmap.

The bitmap itself is constructed in two main steps. First the triangles of each surface are unwrapped onto a 2D surface. Secondly, the colour or other value of each pixel within the bitmap is accumulated by projecting the point data from the point cloud points associated with each triangle. Both processes are described below.

The process for optimally arranging the triangles within a rectangular bitmap is well known and is not described here.

### 4.8.2 Unwrapping the Surface

Note that Pointfuse meshes have been constructed as one or more distinct surfaces. The unwrapping process partitions the triangle meshes of each surface into distinct subsets called cells. At the end of the unwrapping process, each triangle will have been allocated to one of these cells. The wrapped versions of each triangle in a given cell all lie in a single plane and do not overlap each other. In general, if the surface has high curvature, it will be unwrapped into more than one cell.

Each mesh node has two distinct related positions: its wrapped (x, y, z) position in 3D space and its unwrapped (u, v) position in the cell plane. The cell centroid is the mean of the unwrapped positions of the nodes in the cell.

In what follows, triangles are called neighbours if they share a common edge. The unwrapping process is:
1. Stop when all triangles have been allocated to a cell.
2. Select any mesh triangle that has not already been allocated to a cell (initially no triangles have been allocated) and allocate this seed triangle to a new cell.
3. Let [symbol] be all the triangles that are:
   a. Neighbours of at least one triangle in the current cell
   and
   b. Have not already been allocated to a cell.
4. If [symbol] is empty then go to Step 1.
5. Select the neighbour triangle whose common edge midpoint is nearest to the cell centroid. Here the common edge refers to the edge shared by the neighbour triangle and any of the cell triangles.
6. Let the selected common edge be AB and let the other node be C. Let u∈ [symbol] ³ and v∈ [symbol] ³ be orthonormal vectors in the cell plane and let q∈ [symbol] ³ be the cell centroid. Let c∈ [symbol] ³ be the unwrapped position of node C. The wrapped position p of node C is defined as:

$$p = q + α u + β v$$

where α=u^{T}(c−q) and β=v^{T}(c−q). That is, p is the projection of q onto the cell plane.

If the wrapped position p lies outside all triangles in the current cell, then:
a. Remove the selected triangle from [symbol]
b. Add the selected triangle to the cell, marking it as allocated.
c. Go to Step 4.

Otherwise remove the neighbour triangle from [symbol] and go to Step 4.

### 4.8.3 Projecting Point Cloud Points on to the Bitmap

The unwrapped surface is coloured by projecting the point cloud points onto the interior of the original (wrapped) mesh triangles. The corresponding pixel is then coloured in the unwrapped version of the triangle. Two complications arise:
1. A pixel may contain the projection of more than one point cloud point
and
2. A pixel may not contain the projections of any points.

These are dealt with as follows:

### 4.8.3.1 Colour Accumulator with Triangular Blurring

In simple terms, the colour accumulator sums the colour values of every point within a non-empty pixel and then divides that sum by the number of points in that pixel to give the average pixel colour value. In practice, the bitmap image is mixed by distributing the colour information in a small region (the “influence window”) surrounding each non-empty pixel, and computing the average of these distributed values.

In one embodiment of this method, the influence window consists of the 9 pixels surrounding the central non-empty pixel. A separate triangular weighting function is constructed in the X and Y directions. Each function has its maximum value (one) at the projected position of the point cloud point, and has a width of two pixel lengths. The weight used in each pixel is the value of the weight function at the centre of that pixel. A combined weight is now calculated in each pixel in the influence window by multiplying X and Y weights together. Finally, the combined weights are normalized by dividing them by their sum.

### 4.8.3.2 Flood Filling

The non-empty pixels are used to colour the empty pixels. In one embodiment, the process makes use of a filled set which initially consists of all non-empty (and therefore coloured) pixels. A frontier set, consisting of all the empty pixels that are neighbours of coloured pixels, is constructed. All the pixels in the frontier set are given the average of the colours of their neighbouring filled pixels. Once all the frontier pixels have been coloured, they are moved to the filled set and new frontier set is constructed. The process is repeated until any remaining empty pixels do not have filled neighbours.

### 5. “Make Square” Functionality

### 5.1 Introduction to “Make Square” Functionality

Pointfuse Space Creator converts Pointfuse meshes into floor plans of user-selected storeys of a building. For the purposes of this note, each floor plan is treated as a simple graph consisting of nodes and edges. Each edge connects two nodes and represents a wall. Edges are called adjacent if they share a node and are called disjoint otherwise. Each floor plan can be exported for use by third party software. If the angle between two adjacent edges is approximately but not exactly 90 or 180 degrees, the two edges may sometimes be interpreted as disjoint by the third party software. To prevent this from happening, the positions of the wall plan nodes are tweaked, before export, so that all approximate right angles become exact right angles and all approximate straight angles become exact straight angles.

### 5.2 Connected Node Triplets

A connected node triplet Tᵢⱼₖ consists of three nodes {i, j, k} such that node i is connected to both node j and node k. Let pᵢ∈ [symbol] ² be the position of node i, let uᵢⱼ=pⱼ−pᵢ and let

$${\hat{u}}_{i j} = \frac{{u}_{i j}}{\sqrt{{u}_{i j}^{T} {u}_{i j}}}$$

The two unit vectors ûᵢⱼ and ûᵢₖ define the directions of two walls that meet at node i.

The node angle θᵢⱼₖ (in radians) between the two walls is defined by

$${θ}_{i j k} = arc cos ( {\hat{u}}_{i j}^{T} {\hat{u}}_{i k} )$$

The node angle is considered to be approximately a right angle if

$$\vert {θ}_{i j k} - \frac{π}{2} \vert < {θ}_{T O L}$$

and approximately a straight angle if

$$\vert {θ}_{i j k} - π \vert < {θ}_{T O L}$$

where θ_{TOL} is the target angle tolerance in radians. We have found that a suitable target angle tolerance is 5 degrees, that is θ_{TOL}=π/36 radians.

### 5.3 Formulation as Optimization Problem

The problem of tweaking the positions of the wall plan nodes so that node angles that lie within θ_{TOL} of their target angles can be treated as the constrained optimization problem

$$minimize f = {\sum }_{i = 1}^{N} {( {p}_{i} - {p}_{i}^{( 0 )} )}^{T} ( {p}_{i} - {p}_{i}^{( 0 )} )$$

where pᵢ⁽⁰⁾ is the starting position of node i and N is the number of nodes and where the constraints are

$$\frac{{( {p}_{j} - {p}_{i} )}^{T} ( {p}_{k} - {p}_{i} )}{\sqrt{[ {( {p}_{j} - {p}_{i} )}^{T} ( {p}_{j} - {p}_{i} ) ] [ {( {p}_{k} - {p}_{i} )}^{T} ( {p}_{k} - {p}_{i} ) ]}} = cos {τ}_{i j k}$$

where τᵢⱼₖ is the target angle (either π/2 or π) of the connected node triplet Tᵢⱼₖ. Only connected node triplets whose angles lie within θ_{TOL} of one of the target angles are included in the constraints.

The solution algorithm is described in terms of the constrained optimization problem

$$minimize f ( x ) = {( x - {x}^{( 0 )} )}^{T} ( x - {x}^{( 0 )} )$$

subject to m nonlinear constraints

c(x)=0

where x∈ [symbol] ⁿ and x⁽⁰⁾∈ [symbol] ⁿ are n-vectors and where c: [symbol] ⁿ→ [symbol] ^{m} The problem variables x and the position vectors pᵢ are related as follows. Let pᵢ=(Xᵢ, Yᵢ) and pᵢ⁽⁰⁾=(Xᵢ⁽⁰⁾, Yᵢ⁽⁰⁾. Similarly write x=(x₁ . . . xₙ) and x⁽⁰⁾=(x₁⁽⁰⁾ . . . xₙ⁽⁰⁾)^{T}. Then n=2N and for i∈{1 . . . N}

$$\{ \begin{matrix}{x}_{2 i - 1} = {X}_{i} \\ {x}_{2 i} = {Y}_{i}\end{matrix} And$$

$$\{ \begin{matrix}{x}_{2 i - 1}^{( 0 )} = {X}_{i}^{( 0 )} \\ {x}_{2 i}^{( 0 )} = {Y}_{i}^{( 0 )}\end{matrix}$$

### 5.4 Solution Algorithm

Let x⁽⁰⁾∈ [symbol] ⁿ be a given n-vector. This section describes a fast (locally quadratically convergent) numerical method for finding a point in a nonlinear implicit manifold that is locally closest to x⁽⁰⁾. The implicit manifold [symbol] ⊂ [symbol] ⁿ is defined by the m nonlinear equations

$$c ( x ) = 0 \qquad ( 1 )$$

where c: [symbol] ⁿ→ [symbol] ^{m} are a system of m nonlinear continuously differentiable functions. That is

$$ℳ = \{ x ∈ {ℝ}^{n} : c ( x ) = 0 \} .$$

A locally closest point in [symbol] is defined as a local solution x*∈ [symbol] ⁿ of the nonlinearly constrained optimization problem

$$\begin{matrix}minimize f ( x ) = {( x - {x}^{( 0 )} )}^{T} ( x - {x}^{( 0 )} ) \\ subject to c ( x ) = 0\end{matrix} \} \qquad ( P 1 )$$

where the objective function

$$f ( x ) = {( x - {x}^{( 0 )} )}^{T} ( x - {x}^{( 0 )} ) \qquad ( 2 )$$

is the sum of squares of the distances of each variable xᵢ from its starting point xᵢ⁽⁰⁾.

The special structure of this optimization problem allows it to be solved without explicit reference to second derivatives or Lagrange multipliers.

The solution method is iterative. Let x^{(k)} (k≥0) be the starting point of the kth iteration. (In one embodiment of the method, the zeroth iteration starts at the given point x⁽⁰⁾, but this is not essential.) The idea of the method is to linearize the constraints (1) about x^{(k)} and to set the next trial solution x^{(k+1)} equal to the unique point on the linearized constraints that is nearest to x⁽⁰⁾.

In detail, the constraints linearized about x (k) are

$$c ( {x}^{( k )} + Δ {x}^{( k )} ) \approx {c}^{( k )} + {A}_{k} Δ {x}^{( k )} = 0 \qquad ( 3 )$$

where c^{(k)}=c(x^{(k)})∈ [symbol] ^{m} is the m-vector of constraint functions values evaluated at x^{(k)} and Aₖ=∇c(x^{(k)})^{T}∈ [symbol] ^{m×n} is the Jacobian matrix of the constraint functions evaluated at x^{(k)} and Δx^{(k)}=x−x^{(k)}∈ [symbol] ⁿ. It is assumed that at least one of the entries of Aₖ is non-zero.

Because the linearized constraints (3) may not be consistent we pre-multiply (3) by Aₖ^{T} to obtain the normal equations

$${A}_{k}^{T} {A}_{k} Δ {x}^{( k )} = - {A}_{k}^{T} {c}^{( k )} . \qquad ( 4 )$$

By the QR factorization theorem there exists an orthogonal matrix Qₖ∈ [symbol] ^{m×m} and a permutation matrix Pₖ∈ [symbol] ^{n×n} such that

$${A}_{k} = {Q}_{k} ( \begin{matrix}{U}_{k} & {M}_{k} \\ 0 & 0\end{matrix} ) {P}_{k} \qquad ( 5 )$$

where Uₖ∈ [symbol] ^{r×r} is upper triangular and invertible and upper triangular, Mₖ∈ [symbol] ^{r×(n-r)} and r is the rank of Aₖ. If Aₖ is zero then r=0 and the method cannot be used. If Aₖ is of full rank (r=m) then (5) is

$${A}_{k} = {Q}_{k} ( {U}_{k} {M}_{k} ) {P}_{k} .$$

Equations (6), (7) and (8) below remain valid in this special case except that the zero sub-matrices and v^{(k)} are omitted. The equations after (8) are unchanged. Substituting (5) into the normal equations (4) gives

$${P}_{k}^{T} ( \begin{matrix}{U}_{k}^{T} & 0 \\ {M}_{k}^{T} & 0\end{matrix} ) {Q}_{k}^{T} {Q}_{k} ( \begin{matrix}{U}_{k} & {M}_{k} \\ 0 & 0\end{matrix} ) {P}_{k} Δ {x}^{( k )} = - {P}_{k}^{T} ( \begin{matrix}{U}_{k}^{T} & 0 \\ {M}_{k}^{T} & 0\end{matrix} ) {Q}_{k}^{T} {c}^{( k )} . \qquad ( 6 )$$

Pre-multiplying (6) by Pₖ^{-T}=Pₖ gives

$$( \begin{matrix}Δ {y}^{( k )} \\ Δ {z}^{( k )}\end{matrix} ) = {P}_{k} Δ {x}^{( k )}$$

where Δy^{(k)}∈ [symbol] ^{r} and Δz^{(k)}∈ [symbol] ^{n-r} are related by

$$( \begin{matrix}{U}_{k}^{T} & 0 \\ {M}_{k}^{T} & 0\end{matrix} ) ( \begin{matrix}{U}_{k} & {M}_{k} \\ 0 & 0\end{matrix} ) ( \begin{matrix}Δ {y}^{( k )} \\ Δ {z}^{( k )}\end{matrix} ) = ( \begin{matrix}{U}_{k}^{T} & 0 \\ {M}_{k}^{T} & 0\end{matrix} ) ( \begin{matrix}{b}^{( k )} \\ {v}^{( k )}\end{matrix} ) \qquad ( 7 )$$

and b^{(k)}∈ [symbol] ^{r} and v^{(k)}∈ [symbol] ^{m-r} are related by

$$( \begin{matrix}{b}^{( k )} \\ {v}^{( k )}\end{matrix} ) = - {Q}_{k}^{T} {c}^{( k )} . \qquad ( 8 )$$

Multiplying out (7) gives

$$( \begin{matrix}{U}_{k}^{T} {U}_{k} & {U}_{k}^{T} {M}_{k} \\ {M}_{k}^{T} {U}_{k} & {M}_{k}^{T} {M}_{k}\end{matrix} ) ( \begin{matrix}Δ {y}^{( k )} \\ Δ {z}^{( k )}\end{matrix} ) = ( \begin{matrix}{U}_{k}^{T} \\ {M}_{k}^{T}\end{matrix} ) {b}^{( k )} . \qquad ( 9 )$$

The top row of (9) can be simplified as

$${U}_{k} Δ {y}^{( k )} + {M}_{k} Δ {z}^{( k )} = {b}^{( k )} . \qquad ( 10 )$$

Note that the bottom row of (9)

$${M}_{k}^{T} {U}_{k} Δ {y}^{( k )} + {M}_{k}^{T} {M}_{k} Δ {z}^{( k )} = {M}_{k}^{T} {b}^{( k )}$$

provides no further information because it is (10) pre-multiplied by Mₖ^{T}. Equation (10) can be written as

$${U}_{k} ( y - {y}^{( k )} ) + {M}_{k} ( z - {z}^{( k )} ) = {b}^{( k )} \qquad ( 11 )$$

where y−y^{(k)}=Δy^{(k)} and z−z^{(k)}=Δz^{(k)} Equation (11) explicitly partitions the problem variables x into dependent variables y and independent variables z. Equation (11) can be further re-written as

$${U}_{k} [ ( y - {y}^{( 0 )} ) + ( {y}^{( 0 )} - {y}^{( k )} ) ] + {M}_{k} [ ( z - {z}^{( 0 )} ) + ( {z}^{( 0 )} - {z}^{( k )} ) ] = {b}^{( k )} \qquad ( 12 )$$

$$and therefore$$

$${U}_{k} ( y - {y}^{( 0 )} ) + {M}_{k} ( z - {z}^{( 0 )} ) = {b}^{( k )} - {U}_{k} ( {y}^{( 0 )} - {y}^{( k )} ) - {M}_{k} ( {z}^{( 0 )} - {z}^{( k )} ) .$$

Pre-multiplying (12) by Uₖ⁻¹ gives

$$( y - {y}^{0} ) + {W}_{k} ( z - {z}^{( 0 )} ) = {q}^{( k )} \qquad ( 13 )$$

$$where {W}_{k} = {U}_{k}^{- 1} {M}_{k} ∈ {ℝ}^{r \times ( n - r )} and$$

$${q}^{( k )} = {U}_{k}^{- 1} {b}^{( k )} - ( {y}^{( 0 )} - {y}^{( k )} ) - {W}_{k} ( {z}^{( 0 )} - {z}^{( k )} ) .$$

Note that because Uₖ is upper triangular the term s^{(k)}≡Uₖ⁻¹ b^{(k)} in (13) can be computed by solving Uₖs^{(k)}=b^{(k)} by back substitution rather than by explicitly inverting Uₖ. Similarly the matrix Wₖ can be computed by solving UₖWₖ=Mₖ. In this case, each of the n−r columns of Wₖ are computed separately; the jth column wₖ^{(j)}∈ [symbol] ^{r} of Wₖ is computed by solving Uₖwₖ^{(j)}=mₖ^{(j)} where mₖ^{(j)}∈ [symbol] ^{r} is the jth column of Mₖ.

Rearranging (13) gives

$$y - {y}^{( 0 )} = {q}^{( k )} - {W}_{k} ( z - {z}^{( 0 )} ) . \qquad ( 14 )$$

Now the objective function (2) can be written

$$f ( x , y ) = {( y - {y}^{( 0 )} )}^{T} ( y - {y}^{( 0 )} ) + {( z - {z}^{( 0 )} )}^{T} ( z - {z}^{( 0 )} ) . \qquad ( 15 )$$

Using (14) to eliminate the dependent variables y from (15) gives

$$f ( z ) = {[ {q}^{( k )} - {W}_{k} ( z - {z}^{( 0 )} ) ]}^{T} [ {q}^{( k )} - {W}_{k} ( z - {z}^{( 0 )} ) ] + {( z - {z}^{( 0 )} )}^{T} ( z - {z}^{( 0 )} ) . \qquad ( 16 )$$

Multiplying out the first term on the left hand side of (16) and rearranging gives

$$f ( z ) = {( z - {z}^{( 0 )} )}^{T} {G}_{k} ( z - {z}^{( 0 )} ) - 2 {( {q}^{( k )} )}^{T} {W}_{k} ( z - {z}^{( 0 )} ) + {( {q}^{( k )} )}^{T} {q}^{( k )} \qquad ( 17 )$$

$$where {G}_{k} = {I}_{n - r} + {W}_{k}^{T} {W}_{k} ∈ {ℝ}^{( n - r ) \times ( n - r )} and {I}_{n - r} ∈ {ℝ}^{( n - r ) \times ( n - r )}$$

is the unit matrix of order n−r. Note that Gₖ is strictly positive definite and is therefore invertible. A person skilled in the art will recognize that Gₖ is the reduced Hessian matrix of the linearly constrained optimization problem being solved: minimize the sum of squares objective function ƒ(x) subject to the normal equations (4).

The gradient vector of ƒ(z) with respect to the (n−r)-vector of independent variables z is

$${∇}_{a} f = 2 {G}_{k} ( z - {z}^{( 0 )} ) - 2 {W}_{k}^{T} {q}^{( k )} .$$

Setting the gradient vector to zero, dividing by 2 and rearranging gives

$${G}_{k} ( z - {z}^{( 0 )} ) = {W}_{k}^{T} {q}^{( k )} . \qquad ( 18 )$$

$$That is$$

$$z = {z}^{( 0 )} + {G}_{k}^{- 1} {W}_{k}^{T} {q}^{( k )} .$$

Of course someone skilled in the art will compute z by solving the linear equations (18) numerically (for example by Gaussian elimination or Cholesky factorization) rather than by explicitly inverting Gₖ.

To obtain the corresponding values of the dependent variables y, one substitutes z into the linearized constraints (10). Subtracting z^{(k)} from equation (19) gives

$$Δ {z}^{( k )} = z - {z}^{( k )} = {z}^{( 0 )} - {z}^{( k )} + {G}_{k}^{- 1} {W}_{k}^{T} {q}^{( k )} .$$

Substituting Δz^{(k)} into (10) and rearranging gives

$${U}_{k} Δ {y}^{( k )} = {b}^{( k )} - {M}_{k} [ {z}^{( 0 )} - {z}^{( k )} + {G}_{k}^{- 1} {W}_{k}^{T} {q}^{( k )} ] . \qquad ( 20 )$$

Because Uₖ is upper triangular, the value of Δy^{(k)} can be obtained from (20) by backward substitution.

The new trial solution x^{(k+1)} is given by

$${x}^{( k + 1 )} = {x}^{( k )} + Δ {x}^{( k )} . \qquad ( 21 )$$

Let [symbol] (x, R)={u∈ [symbol] ⁿ: ∥u−x∥₂<R} be the open ball with centre at x∈ [symbol] ⁿ and R>0 is the radius. Here ∥ ∥₂ is the Euclidean or L² norm. An n-vector x*∈ [symbol] ⁿ is a local solution of (P1) if c(x*)=0 and there exists a positive R>such that ƒ(x*)≤ƒ(x) for all x∈ [symbol] (x*, R).

Our experience is that the sequence of trial solutions x^{(k)} always converges rapidly to a local solution x*∈ [symbol] ⁿ of (P1), probably because the starting point x⁽⁰⁾ is sufficiently close to x*, however there is no theoretical guarantee that convergence will occur unless additional measures are taken.

For example, in one embodiment, the simple update equation (21) is replaced by

$${x}^{( k + 1 )} = {z}^{( k )} + {α}_{k} Δ {x}^{( k )} \qquad ( 22 )$$

where 0<aₖ≤1 is called the step length and is chosen in such a way as to ensure convergence.

In detail, let g(x) be the sum of the squares of the constraint function values at x. That is

$$g ( x ) = {c ( x )}^{T} c ( x ) .$$

$$Then$$

$$∇ g ( x ) = 2 ∇ c ( x ) c ( x ) .$$

$$Let {h}_{k} = ∇ g ( {x}^{( k )} ) = 2 {A}_{k}^{T} {c}_{k} . Then$$

$${h}_{k} = 2 {P}_{k}^{T} ( \begin{matrix}{U}_{k}^{T} & 0 \\ {M}_{k}^{T} & 0\end{matrix} ) {Q}_{k}^{T} {c}_{k} = - 2 {P}_{k}^{T} ( \begin{matrix}{U}_{k}^{T} & 0 \\ {M}_{k}^{T} & 0\end{matrix} ) ( \begin{matrix}{b}^{( k )} \\ {v}^{( k )}\end{matrix} ) = - 2 {P}_{k}^{T} ( \begin{matrix}{U}_{k}^{T} \\ {M}_{k}^{T}\end{matrix} ) {b}^{( k )}$$

$$That is$$

$${h}_{k}^{T} Δ {x}^{( k )} = - 2 ( {b}^{( k )} ) ( {U}_{k} {M}_{k} ) {P}_{k} Δ {x}^{( k )} = - 2 {( {b}^{( k )} )}^{T} ( {U}_{k} {M}_{k} ) ( \begin{matrix}Δ {y}^{( k )} \\ Δ {z}^{( k )}\end{matrix} )$$

$$That is$$

$${g}_{k}^{T} Δ {x}^{( k )} = - 2 {( {b}^{( k )} )}^{T} ( {U}_{k} Δ {y}^{( k )} + {M}_{k} Δ {z}^{( k )} )$$

where g^{(k)}=g(x^{(k)}). But by construction

$${U}_{k} Δ {y}^{( k )} + {M}_{k} Δ {z}^{( k )} = {b}^{( k )}$$

$$Therefore$$

$${h}_{k}^{T} Δ {x}^{( k )} = - 2 {( {b}^{( k )} )}^{T} {b}^{( k )}$$

$$Now$$

$$( \begin{matrix}{b}^{( k )} \\ {v}^{( k )}\end{matrix} ) = - {Q}_{k}^{T} {c}^{( k )}$$

$$Therefore$$

$${( {b}^{( k )} )}^{T} {b}^{( k )} + {( {v}^{( k )} )}^{T} {v}^{( k )} = {( {c}^{( k )} )}^{T} {c}^{( k )}$$

$$Therefore$$

$${h}_{k}^{T} Δ {x}^{( k )} < - 2 {( {c}^{( k )} )}^{T} {c}^{( k )} ,$$

showing that unless x^{(k)} already satisfies the constraints, Δx^{(k)} is a descent direction of g at x^{(k)}. In particular, provided only that Aₖ is non-zero, it follows that if x^{(k+1)} is computed using (22) then

$${g}_{k + 1} = g ( {x}^{( k + 1 )} ) < {g}_{k} \qquad ( 23 )$$

for all sufficiently small step lengths αₖ>0.

Initially set αₖ to one, and progressively multiply αₖ by a constant reduction factor 0<ω<1 (for example ω=0.5 or ω=0.1) until (23) is satisfied.

### 5.5 Computation of the Constraint Derivatives

It remains to explain how the derivatives of the constraint functions are calculated. The position vector of node i is

$${p}_{i} = ( \begin{matrix}{x}_{2 i - 1} \\ {x}_{2 i}\end{matrix} )$$

$$so that$$

$${u}_{ij} = {p}_{j} - {p}_{i} = ( \begin{matrix}{u}_{ij 1} \\ {u}_{ij 2}\end{matrix} ) = ( \begin{matrix}{x}_{2 j - 1} - {x}_{2 i - 1} \\ {x}_{2 j} - {x}_{2 i}\end{matrix} ) .$$

The constraint associated with connected node triplet Ty can be written as

$${c}_{ijk} = {( {\hat{u}}_{ij} )}^{T} {\hat{u}}_{ik} - cos {τ}_{ijk} = {\hat{u}}_{ij 1} {\hat{u}}_{ik 1} + {\hat{u}}_{ij 2} {\hat{u}}_{ik 2} = {\sum }_{s = 1}^{2} {\hat{u}}_{ijs} {\hat{u}}_{iks} ,$$

where τᵢⱼₖ is the corresponding target angle and

$${\hat{u}}_{ijs} = \frac{{u}_{ijs}}{\sqrt{{u}_{ij 1}^{2} + {u}_{ij 2}^{2}}} .$$

It follows that

$$\frac{\partial {c}_{ijk}}{\partial {x}_{r}} = {\sum }_{s = 1}^{2} ( \frac{\partial {\hat{u}}_{ijs}}{\partial {x}_{r}} {\hat{u}}_{iks} + {\hat{u}}_{ijs} \frac{{\hat{u}}_{iks}}{\partial {x}_{r}} ) .$$

$$Now$$

$$\frac{\partial {\hat{u}}_{ijs}}{\partial {x}_{r}} = \frac{( \sqrt{{u}_{ij 1}^{2} + {u}_{ij 2}^{2}} ) \frac{\partial {u}_{ijs}}{\partial {x}_{r}} - {u}_{ijs} \frac{\partial }{\partial {x}_{r}} ( \sqrt{{u}_{ij 1}^{2} + {u}_{ij 2}^{2}} )}{{u}_{ij 1}^{2} + {u}_{ij 2}^{2}} ,$$

$$where$$

$$\frac{\partial }{\partial {x}_{r}} ( \sqrt{{u}_{ij 1}^{2} + {u}_{ij 2}^{2}} ) = \frac{1}{2} \frac{1}{\sqrt{{u}_{ij 1}^{2} + {u}_{ij 2}^{2}}} \frac{\partial }{\partial {x}_{r}} ( {u}_{ij 1}^{2} + {u}_{ij 2}^{2} ) ,$$

$$and therefore ,$$

$$\frac{\partial }{\partial {x}_{r}} ( \sqrt{{u}_{ij 1}^{2} + {u}_{ij 2}^{2}} ) = \frac{1}{2} \frac{1}{\sqrt{{u}_{ij 1}^{2} + {u}_{ij 2}^{2}}} ( 2 \frac{\partial {u}_{ijk}}{\partial {x}_{r}} {u}_{ij 1} + 2 \frac{\partial {u}_{ijk}}{\partial {x}_{r}} {u}_{ij 2} ) ,$$

$$so that$$

$$\frac{\partial }{\partial {x}_{r}} ( \sqrt{{u}_{ij 1}^{2} + {u}_{ij 2}^{2}} ) = \frac{1}{\sqrt{{u}_{ij 1}^{2} + {u}_{ij 2}^{2}}} ( \frac{\partial {u}_{ijk}}{\partial {x}_{r}} {u}_{ij 1} + \frac{\partial {u}_{ijk}}{\partial {x}_{r}} {u}_{ij 2} ) .$$

$$Also {u}_{ij 1} = {x}_{2 j - 1} - {x}_{2 i - 1} so that$$

$$\frac{\partial {u}_{ij 1}}{\partial {x}_{r}} = \{ \begin{matrix}1 & if r = 2 j - 1 \\ - 1 & if r = 2 i - 1 \\ 0 & otherwise\end{matrix}$$

$$Similarly$$

$$\frac{\partial {u}_{ij 2}}{\partial {x}_{r}} = \{ \begin{matrix}1 & if r = 2 j \\ - 1 & if r = 2 i \\ 0 & otherwise\end{matrix}$$

As in WO 2014/132020 A1, aspects of the invention can be carried out using suitable devices and apparatus, such as a scanning module, processing module, point cloud database, or computer etc.

Elements of the description can be combined with each other, and with elements of WO 2014/132020 A1.

### 6. Table

TABLE 1
Polygon Winding Map

| Case | bits | vertexes | Case | bits | vertexes | Case | bits | Vertexes |
|---|---|---|---|---|---|---|---|---|
| 0 | 15 | 0, 1, 2, 3 | 86 | 4146 | 12, 4, 5, 1 | 172 | 32844 | 3, 15, 6, 2 |
| 1 | 26 | 1, 3, 4 | 87 | 4148 | 12, 4, 5, 2 | 173 | 33064 | 8, 3, 15, 5 |
| 2 | 37 | 0, 5, 2 | 88 | 4180 | 12, 2, 6, 4 | 174 | 33345 | 0, 9, 6, 15 |
| 3 | 51 | 0, 4, 5, 1 | 89 | 4228 | 12, 7, 2 | 175 | 33797 | 0, 2, 10, 15 |
| 4 | 60 | 3, 4, 5, 2 | 90 | 4258 | 1, 12, 7, 5 | 176 | 33800 | 3, 10, 15 |
| 5 | 74 | 1, 3, 6 | 91 | 4290 | 12, 7, 6, 1 | 177 | 33801 | 0, 3, 10, 15 |
| 6 | 82 | 4, 6, 1 | 92 | 4292 | 12, 7, 6, 2 | 178 | 33804 | 3, 15, 10, 2 |
| 7 | 85 | 0, 2, 6, 4 | 93 | 4368 | 8, 12, 4 | 179 | 34305 | 0, 9, 10, 15 |
| 8 | 88 | 3, 6, 4 | 94 | 4400 | 12, 4, 5, 8 | 180 | 34817 | 0, 15, 11 |
| 9 | 102 | 1, 2, 6, 5 | 95 | 4496 | 8, 12, 7, 4 | 181 | 34819 | 0, 15, 11, 1 |
| 10 | 105 | 0, 3, 6, 5 | 96 | 4512 | 8, 12, 7, 5 | 182 | 34825 | 0, 3, 15, 11 |
| 11 | 133 | 0, 7, 2 | 97 | 4688 | 12, 9, 6, 4 | 183 | 34826 | 1, 3, 15, 11 |
| 12 | 150 | 1, 2, 7, 4 | 98 | 4736 | 12, 7, 9 | 184 | 35080 | 8, 3, 15, 11 |
| 13 | 153 | 0, 3, 7, 4 | 99 | 4752 | 12, 9, 7, 4 | 185 | 36898 | 12, 15, 5, 1 |
| 14 | 161 | 0, 7, 5 | 100 | 4800 | 12, 7, 6, 9 | 186 | 36900 | 12, 15, 5, 2 |
| 15 | 164 | 2, 7, 5 | 101 | 5140 | 12, 2, 10, 4 | 187 | 36930 | 12, 15, 6, 1 |
| 16 | 170 | 1, 3, 7, 5 | 102 | 5648 | 12, 9, 10, 4 | 188 | 36932 | 12, 15, 6, 2 |
| 17 | 195 | 0, 7, 6, 1 | 103 | 6274 | 1, 12, 7, 11 | 189 | 37152 | 12, 15, 5, 8 |
| 18 | 204 | 3, 7, 6, 2 | 104 | 6528 | 8, 12, 7, 11 | 190 | 37440 | 12, 15, 6, 9 |
| 19 | 240 | 4, 5, 6, 7 | 105 | 8225 | 0, 5, 13 | 191 | 37892 | 12, 15, 10, 2 |
| 20 | 280 | 8, 3, 4 | 106 | 8241 | 0, 4, 5, 13 | 192 | 38400 | 12, 9, 10, 15 |
| 21 | 292 | 8, 2, 5 | 107 | 8248 | 3, 4, 5, 13 | 193 | 38914 | 12, 15, 11, 1 |
| 22 | 340 | 8, 2, 6, 4 | 108 | 8264 | 3, 6, 13 | 194 | 39168 | 8, 12, 15, 11 |
| 23 | 356 | 8, 2, 6, 5 | 109 | 8273 | 0, 13, 6, 4 | 195 | 40993 | 0, 15, 5, 13 |
| 24 | 360 | 8, 3, 6, 5 | 110 | 8360 | 13, 3, 7, 5 | 196 | 41000 | 13, 3, 15, 5 |
| 25 | 404 | 8, 2, 7, 4 | 111 | 8385 | 0, 7, 6, 13 | 197 | 41025 | 0, 13, 6, 15 |
| 26 | 408 | 8, 3, 7, 4 | 112 | 8392 | 3, 7, 6, 13 | 198 | 41032 | 3, 15, 6, 13 |
| 27 | 424 | 8, 3, 7, 5 | 113 | 8480 | 5, 13, 8 | 199 | 45088 | 12, 15, 5, 13 |
| 28 | 578 | 1, 9, 6 | 114 | 8496 | 8, 4, 5, 13 | 200 | 45120 | 12, 15, 6, 13 |
| 29 | 593 | 0, 9, 6, 4 | 115 | 8528 | 8, 13, 6, 4 | 201 | 49155 | 0, 15, 14, 1 |
| 30 | 609 | 0, 9, 6, 5 | 116 | 8544 | 8, 13, 6, 5 | 202 | 49157 | 0, 2, 14, 15 |
| 31 | 610 | 1, 9, 6, 5 | 117 | 8768 | 13, 9, 6 | 203 | 49162 | 1, 3, 15, 14 |
| 32 | 641 | 0, 9, 7 | 118 | 8800 | 13, 9, 6, 5 | 204 | 49164 | 3, 15, 14, 2 |
| 33 | 657 | 0, 9, 7, 4 | 119 | 8864 | 13, 9, 7, 5 | 205 | 53250 | 12, 15, 14, 1 |
| 34 | 658 | 1, 9, 7, 4 | 120 | 8896 | 9, 7, 6, 13 | 206 | 53252 | 12, 15, 14, 2 |
| 35 | 674 | 1, 9, 7, 5 | 121 | 9256 | 13, 3, 10, 5 | 207 | 57345 | 0, 15, 14, 13 |
| 36 | 848 | 8, 9, 6, 4 | 122 | 9760 | 13, 9, 10, 5 | 208 | 57352 | 3, 15, 14, 13 |
| 37 | 864 | 8, 9, 6, 5 | 123 | 10305 | 0, 13, 6, 11 | 209 | 61440 | 12, 15, 14, 13 |
| 38 | 912 | 8, 9, 7, 4 | 124 | 10560 | 8, 13, 6, 11 | 210 | 65546 | 16, 1, 3 |
| 39 | 928 | 8, 9, 7, 5 | 125 | 12336 | 12, 4, 5, 13 | 211 | 65550 | 16, 1, 2, 3 |
| 40 | 1045 | 0, 2, 10, 4 | 126 | 12368 | 12, 13, 6, 4 | 212 | 65580 | 3, 16, 5, 2 |
| 41 | 1046 | 1, 2, 10, 4 | 127 | 12448 | 13, 12, 7, 5 | 213 | 65640 | 16, 3, 6, 5 |
| 42 | 1048 | 3, 10, 4 | 128 | 12480 | 12, 7, 6, 13 | 214 | 65670 | 1, 2, 7, 16 |
| 43 | 1049 | 0, 3, 10, 4 | 129 | 16402 | 4, 14, 1 | 215 | 65696 | 16, 5, 7 |
| 44 | 1060 | 2, 10, 5 | 130 | 16403 | 0, 4, 14, 1 | 216 | 65730 | 16, 7, 6, 1 |
| 45 | 1062 | 1, 2, 10, 5 | 131 | 16405 | 0, 2, 14, 4 | 217 | 65760 | 16, 5, 6, 7 |
| 46 | 1065 | 0, 3, 10, 5 | 132 | 16412 | 3, 4, 14, 2 | 218 | 65800 | 16, 8, 3 |
| 47 | 1066 | 1, 3, 10, 5 | 133 | 16515 | 0, 7, 14, 1 | 219 | 65804 | 16, 8, 2, 3 |
| 48 | 1300 | 8, 2, 10, 4 | 134 | 16516 | 7, 14, 2 | 220 | 65924 | 8, 2, 7, 16 |
| 49 | 1304 | 8, 3, 10, 4 | 135 | 16522 | 1, 3, 7, 14 | 221 | 65928 | 8, 3, 7, 16 |
| 50 | 1316 | 8, 2, 10, 5 | 136 | 16524 | 3, 7, 14, 2 | 222 | 66178 | 1, 9, 7, 16 |
| 51 | 1320 | 8, 3, 10, 5 | 137 | 16660 | 8, 2, 14, 4 | 223 | 66432 | 8, 9, 7, 16 |
| 52 | 1553 | 0, 9, 10, 4 | 138 | 17026 | 1, 9, 7, 14 | 224 | 66600 | 16, 3, 10, 5 |
| 53 | 1554 | 1, 9, 10, 4 | 139 | 17412 | 10, 14, 2 | 225 | 67656 | 16, 3, 6, 11 |
| 54 | 1569 | 0, 9, 10, 5 | 140 | 17414 | 1, 2, 10, 14 | 226 | 67712 | 7, 11, 16 |
| 55 | 1570 | 1, 9, 10, 5 | 141 | 17418 | 1, 3, 10, 14 | 227 | 67720 | 16, 3, 7, 11 |
| 56 | 1808 | 8, 9, 10, 4 | 142 | 17420 | 3, 10, 14, 2 | 228 | 67776 | 16, 11, 6, 7 |
| 57 | 1824 | 8, 9, 10, 5 | 143 | 17922 | 1, 9, 10, 14 | 229 | 68616 | 3, 10, 11, 16 |
| 58 | 2114 | 1, 6, 11 | 144 | 18434 | 1, 14, 11 | 230 | 69634 | 12, 16, 1 |
| 59 | 2117 | 0, 2, 6, 11 | 145 | 18435 | 0, 11, 14, 1 | 231 | 69638 | 16, 1, 2, 12 |
| 60 | 2118 | 1, 2, 6, 11 | 146 | 18437 | 0, 2, 14, 11 | 232 | 69666 | 12, 16, 5, 1 |
| 61 | 2121 | 0, 3, 6, 11 | 147 | 18438 | 1, 2, 14, 11 | 233 | 69668 | 12, 16, 5, 2 |
| 62 | 2177 | 0, 7, 11 | 148 | 18692 | 8, 2, 14, 11 | 234 | 69888 | 8, 12, 16 |
| 63 | 2182 | 1, 2, 7, 11 | 149 | 20498 | 12, 4, 14, 1 | 235 | 71200 | 16, 5, 10, 9, 12 |
| 64 | 2185 | 0, 3, 7, 11 | 150 | 20500 | 12, 2, 14, 4 | 236 | 72256 | 12, 9, 6, 11, 16 |
| 65 | 2186 | 1, 3, 7, 11 | 151 | 20610 | 1, 12, 7, 14 | 237 | 72320 | 12, 9, 7, 11, 16 |
| 66 | 2372 | 8, 2, 6, 11 | 152 | 20612 | 12, 7, 14, 2 | 238 | 72708 | 12, 16, 11, 10, 2 |
| 67 | 2376 | 8, 3, 6, 11 | 153 | 24593 | 0, 4, 14, 13 | 239 | 73216 | 12, 9, 10, 11, 16 |
| 68 | 2436 | 8, 2, 7, 11 | 154 | 24600 | 3, 4, 14, 13 | 240 | 73768 | 3, 16, 5, 13 |
| 69 | 2440 | 8, 3, 7, 11 | 155 | 24705 | 0, 7, 14, 13 | 241 | 77856 | 12, 16, 5, 13 |
| 70 | 2625 | 0, 9, 6, 11 | 156 | 24712 | 3, 7, 14, 13 | 242 | 79936 | 12, 13, 6, 11, 16 |
| 71 | 2626 | 1, 9, 6, 11 | 157 | 24848 | 4, 14, 13, 8 | 243 | 82050 | 16, 7, 14, 1 |
| 72 | 2689 | 0, 9, 7, 11 | 158 | 25216 | 7, 14, 13, 9 | 244 | 88066 | 12, 16, 11, 14, 1 |
| 73 | 2690 | 1, 9, 7, 11 | 159 | 25608 | 3, 10, 14, 13 | 245 | 88068 | 12, 16, 11, 14, 2 |
| 74 | 2880 | 8, 9, 6, 11 | 160 | 26112 | 13, 9, 10, 14 | 246 | 90496 | 16, 8, 13, 14, 7 |
| 75 | 2944 | 8, 9, 7, 11 | 161 | 26625 | 0, 11, 14, 13 | 247 | 92168 | 16, 11, 14, 13, 3 |
| 76 | 3077 | 0, 2, 10, 11 | 162 | 26880 | 11, 14, 13, 8 | 248 | 96256 | 12, 16, 11, 14, 13 |
| 77 | 3078 | 1, 2, 10, 11 | 163 | 28688 | 12, 4, 14, 13 | 249 | 98336 | 16, 5, 15 |
| 78 | 3081 | 0, 3, 10, 11 | 164 | 28800 | 12, 7, 14, 13 | 250 | 98338 | 16, 15, 5, 1 |
| 79 | 3082 | 1, 3, 10, 11 | 165 | 32801 | 0, 15, 5 | 251 | 98370 | 16, 15, 6, 1 |
| 80 | 3332 | 8, 2, 10, 11 | 166 | 32803 | 0, 15, 5, 1 | 252 | 98400 | 16, 5, 6, 15 |
| 81 | 3336 | 8, 3, 10, 11 | 167 | 32810 | 1, 3, 15, 5 | 253 | 99136 | 16, 15, 6, 9, 8 |
| 82 | 3585 | 0, 9, 10, 11 | 168 | 32812 | 3, 15, 5, 2 | 254 | 99588 | 8, 2, 10, 15, 16 |
| 83 | 3586 | 1, 9, 10, 11 | 169 | 32835 | 0, 15, 6, 1 | 255 | 99592 | 8, 3, 10, 15, 16 |
| 84 | 3840 | 8, 9, 10, 11 | 170 | 32837 | 0, 2, 6, 15 | 256 | 99842 | 16, 1, 9, 10, 15 |
| 85 | 4114 | 12, 4, 1 | 171 | 32840 | 3, 15, 6 | 257 | 100096 | 8, 9, 10, 15, 16 |
| 258 | 100352 | 15, 11, 16 | 344 | 262440 | 8, 3, 18, 5 | 430 | 524293 | 0, 2, 19 |
| 259 | 106784 | 16, 15, 5, 13, 8 | 345 | 262658 | 1, 18, 9 | 431 | 524295 | 0, 1, 2, 19 |
| 260 | 106816 | 16, 15, 6, 13, 8 | 346 | 262659 | 0, 1, 18, 9 | 432 | 524310 | 1, 2, 19, 4 |
| 261 | 114690 | 16, 15, 14, 1 | 347 | 262689 | 0, 9, 18, 5 | 433 | 524340 | 19, 4, 5, 2 |
| 262 | 114948 | 8, 2, 14, 15, 16 | 348 | 262690 | 1, 9, 18, 5 | 434 | 524355 | 0, 19, 6, 1 |
| 263 | 123136 | 16, 15, 14, 13, 8 | 349 | 262944 | 8, 9, 18, 5 | 435 | 524368 | 4, 6, 19 |
| 264 | 131077 | 0, 17, 2 | 350 | 263186 | 1, 18, 10, 4 | 436 | 524385 | 0, 19, 6, 5 |
| 265 | 131085 | 0, 17, 2, 3 | 351 | 263200 | 18, 10, 5 | 437 | 524400 | 4, 5, 6, 19 |
| 266 | 131100 | 3, 4, 17, 2 | 352 | 263202 | 1, 18, 10, 5 | 438 | 524564 | 8, 2, 19, 4 |
| 267 | 131145 | 0, 3, 6, 17 | 353 | 263216 | 4, 5, 18, 10 | 439 | 524801 | 0, 9, 19 |
| 268 | 131152 | 4, 17, 6 | 354 | 264322 | 1, 18, 7, 11 | 440 | 524803 | 0, 1, 9, 19 |
| 269 | 131220 | 17, 2, 7, 4 | 355 | 265218 | 1, 18, 10, 11 | 441 | 524817 | 0, 9, 19, 4 |
| 270 | 131265 | 0, 7, 6, 17 | 356 | 266370 | 12, 7, 18, 1 | 442 | 524818 | 1, 9, 19, 4 |
| 271 | 131280 | 4, 17, 6, 7 | 357 | 270344 | 3, 18, 13 | 443 | 525072 | 8, 9, 19, 4 |
| 272 | 131332 | 8, 2, 17 | 358 | 270345 | 0, 13, 18, 3 | 444 | 525328 | 4, 10, 19 |
| 273 | 131340 | 8, 17, 2, 3 | 359 | 270465 | 0, 7, 18, 13 | 445 | 525329 | 0, 19, 10, 4 |
| 274 | 131396 | 8, 2, 6, 17 | 360 | 270472 | 3, 7, 18, 13 | 446 | 525345 | 0, 19, 10, 5 |
| 275 | 131400 | 8, 3, 6, 17 | 361 | 270848 | 13, 9, 18 | 447 | 525360 | 4, 5, 10, 19 |
| 276 | 131649 | 0, 9, 6, 17 | 362 | 271632 | 8, 13, 18, 10, 4 | 448 | 526401 | 0, 19, 6, 11 |
| 277 | 131904 | 8, 9, 6, 17 | 363 | 271648 | 8, 13, 18, 10, 5 | 449 | 527361 | 0, 19, 10, 11 |
| 278 | 132116 | 17, 2, 10, 4 | 364 | 272768 | 11, 8, 13, 18, 7 | 450 | 528388 | 2, 19, 12 |
| 279 | 133184 | 11, 17, 6 | 365 | 273409 | 0, 11, 10, 18, 13 | 451 | 528390 | 12, 1, 2, 19 |
| 280 | 133188 | 17, 2, 6, 11 | 366 | 273664 | 8, 13, 18, 10, 11 | 452 | 528450 | 12, 19, 6, 1 |
| 281 | 133252 | 17, 2, 7, 11 | 367 | 274560 | 12, 7, 18, 13 | 453 | 528452 | 12, 19, 6, 2 |
| 282 | 133312 | 11, 17, 6, 7 | 368 | 275472 | 12, 13, 18, 10, 4 | 454 | 528896 | 12, 19, 9 |
| 283 | 134148 | 2, 10, 11, 17 | 369 | 278552 | 3, 4, 14, 18 | 455 | 529680 | 8, 12, 19, 10, 4 |
| 284 | 135188 | 12, 4, 17, 2 | 370 | 278656 | 14, 18, 7 | 456 | 529696 | 8, 12, 19, 10, 5 |
| 285 | 139265 | 0, 17, 13 | 371 | 278664 | 3, 7, 14, 18 | 457 | 530752 | 8, 11, 6, 19, 12 |
| 286 | 139273 | 0, 17, 13, 3 | 372 | 278672 | 4, 14, 18, 7 | 458 | 531458 | 12, 19, 10, 11, 1 |
| 287 | 139281 | 0, 4, 17, 13 | 373 | 279312 | 8, 4, 14, 18, 9 | 459 | 531712 | 8, 12, 19, 10, 11 |
| 288 | 139288 | 3, 4, 17, 13 | 374 | 279552 | 18, 10, 14 | 460 | 532545 | 0, 19, 6, 13 |
| 289 | 139520 | 8, 13, 17 | 375 | 280840 | 8, 11, 14, 18, 3 | 461 | 536640 | 12, 19, 6, 13 |
| 290 | 140816 | 4, 17, 13, 9, 10 | 376 | 281089 | 0, 9, 18, 14, 11 | 462 | 537632 | 13, 12, 19, 10, 5 |
| 291 | 141888 | 13, 9, 6, 11, 17 | 377 | 281090 | 1, 9, 18, 14, 11 | 463 | 540692 | 19, 4, 14, 2 |
| 292 | 141952 | 13, 9, 7, 11, 17 | 378 | 281344 | 8, 9, 18, 14, 11 | 464 | 545794 | 12, 19, 10, 14, 1 |
| 293 | 142344 | 3, 10, 11, 17, 13 | 379 | 283152 | 12, 4, 14, 18, 9 | 465 | 545796 | 12, 19, 10, 14, 2 |
| 294 | 142848 | 13, 9, 10, 11, 17 | 380 | 283264 | 12, 7, 14, 18, 9 | 466 | 549392 | 4, 14, 13, 9, 19 |
| 295 | 143376 | 12, 4, 17, 13 | 381 | 294952 | 3, 15, 5, 18 | 467 | 549889 | 0, 13, 14, 10, 19 |
| 296 | 145536 | 13, 12, 7, 11, 17 | 382 | 299552 | 15, 5, 18, 9, 12 | 468 | 553984 | 12, 19, 10, 14, 13 |
| 297 | 147472 | 4, 14, 17 | 383 | 300034 | 12, 1, 18, 10, 15 | 469 | 557092 | 19, 15, 5, 2 |
| 298 | 147473 | 0, 4, 14, 17 | 384 | 304129 | 0, 15, 10, 18, 13 | 470 | 557120 | 19, 15, 6 |
| 299 | 147585 | 0, 7, 14, 17 | 385 | 304136 | 3, 15, 10, 18, 13 | 471 | 557124 | 19, 15, 6, 2 |
| 300 | 147600 | 4, 17, 14, 7 | 386 | 308224 | 12, 15, 10, 18, 13 | 472 | 557152 | 15, 5, 6, 19 |
| 301 | 148352 | 9, 7, 14, 17, 8 | 387 | 311304 | 3, 15, 14, 18 | 473 | 557856 | 19, 15, 5, 8, 9 |
| 302 | 148740 | 8, 2, 10, 14, 17 | 388 | 311809 | 0, 9, 18, 14, 15 | 474 | 558080 | 19, 15, 10 |
| 303 | 148744 | 8, 3, 10, 14, 17 | 389 | 315904 | 12, 15, 14, 18, 9 | 475 | 559364 | 11, 8, 2, 19, 15 |
| 304 | 148993 | 0, 17, 14, 10, 9 | 390 | 327690 | 16, 1, 18, 3 | 476 | 559617 | 0, 9, 19, 15, 11 |
| 305 | 149248 | 8, 9, 10, 14, 17 | 391 | 327720 | 3, 16, 5, 18 | 477 | 559618 | 1, 9, 19, 15, 11 |
| 306 | 149504 | 11, 14, 17 | 392 | 327810 | 16, 7, 18, 1 | 478 | 559872 | 8, 9, 19, 15, 11 |
| 307 | 151824 | 12, 4, 14, 17, 8 | 393 | 327840 | 16, 5, 18, 7 | 479 | 565792 | 19, 15, 5, 13, 9 |
| 308 | 151936 | 12, 7, 14, 17, 8 | 394 | 332290 | 16, 1, 18, 9, 12 | 480 | 565824 | 19, 15, 6, 13, 9 |
| 309 | 163905 | 0, 15, 6, 17 | 395 | 332320 | 16, 5, 18, 9, 12 | 481 | 573444 | 19, 15, 14, 2 |
| 310 | 168256 | 8, 17, 6, 15, 12 | 396 | 336136 | 16, 8, 13, 18, 3 | 482 | 573954 | 1, 9, 19, 15, 14 |
| 311 | 169988 | 11, 17, 2, 12, 15 | 397 | 336256 | 16, 8, 13, 18, 7 | 483 | 582144 | 19, 15, 14, 13, 9 |
| 312 | 174081 | 0, 15, 11, 17, 13 | 398 | 340736 | 16, 8, 13, 18, 9, 12 | 484 | 589830 | 16, 1, 2, 19 |
| 313 | 174088 | 3, 15, 11, 17, 13 | 399 | 343040 | 12, 13, 18, 10, 11, 16 | 485 | 589860 | 19, 16, 5, 2 |
| 314 | 178176 | 12, 15, 11, 17, 13 | 400 | 346120 | 16, 11, 14, 18, 3 | 486 | 589890 | 16, 19, 6, 1 |
| 315 | 180225 | 0, 15, 14, 17 | 401 | 346240 | 16, 11, 14, 18, 7 | 487 | 589920 | 16, 5, 6, 19 |
| 316 | 180488 | 8, 3, 15, 14, 17 | 402 | 350720 | 12, 9, 18, 14, 11, 16 | 488 | 590084 | 16, 8, 2, 19 |
| 317 | 184576 | 12, 15, 14, 17, 8 | 403 | 361474 | 16, 1, 18, 10, 15 | 489 | 590338 | 16, 1, 9, 19 |
| 318 | 196620 | 16, 17, 2, 3 | 404 | 361504 | 16, 5, 18, 10, 15 | 490 | 590592 | 8, 9, 19, 16 |
| 319 | 196680 | 16, 3, 6, 17 | 405 | 369920 | 16, 15, 10, 18, 13, 8 | 491 | 590880 | 16, 5, 10, 19 |
| 320 | 196740 | 17, 2, 7, 16 | 406 | 377600 | 8, 16, 15, 14, 18, 9 | 492 | 591936 | 16, 11, 6, 19 |
| 321 | 196800 | 16, 17, 6, 7 | 407 | 379904 | 18, 14, 11, 16, 15, 10 | 493 | 592896 | 19, 10, 11, 16 |
| 322 | 200708 | 16, 17, 2, 12 | 408 | 393225 | 0, 17, 18, 3 | 494 | 598336 | 16, 19, 6, 13, 8 |
| 323 | 201280 | 12, 9, 6, 17, 16 | 409 | 393240 | 3, 4, 17, 18 | 495 | 598560 | 19, 16, 5, 13, 9 |
| 324 | 204808 | 16, 17, 13, 3 | 410 | 393345 | 0, 7, 18, 17 | 496 | 607234 | 16, 19, 10, 14, 1 |
| 325 | 205440 | 13, 9, 7, 16, 17 | 411 | 393360 | 4, 17, 18, 7 | 497 | 608260 | 19, 16, 11, 14, 2 |
| 326 | 208896 | 12, 16, 17, 13 | 412 | 393480 | 8, 17, 18, 3 | 498 | 615680 | 16, 8, 13, 14, 10, 19 |
| 327 | 213120 | 16, 17, 14, 7 | 413 | 393729 | 0, 17, 18, 9 | 499 | 616960 | 16, 11, 14, 13, 9, 19 |
| 328 | 214024 | 16, 3, 10, 14, 17 | 414 | 393984 | 8, 9, 18, 17 | 500 | 627968 | 8, 12, 19, 10, 15, 16 |
| 329 | 218624 | 16, 17, 14, 10, 9, 12 | 415 | 394256 | 4, 17, 18, 10 | 501 | 629248 | 9, 19, 15, 11, 16, 12 |
| 330 | 219392 | 12, 16, 11, 14, 17, 8 | 416 | 395392 | 11, 17, 18, 7 | 502 | 655365 | 0, 17, 2, 19 |
| 331 | 229440 | 16, 17, 6, 15 | 417 | 396288 | 18, 10, 11, 17 | 503 | 655380 | 19, 4, 17, 2 |
| 332 | 230404 | 17, 2, 10, 15, 16 | 418 | 397696 | 12, 7, 18, 17, 8 | 504 | 655425 | 0, 19, 6, 17 |
| 333 | 239104 | 16, 17, 13, 9, 10, 15 | 419 | 397840 | 12, 4, 17, 18, 9 | 505 | 655440 | 4, 17, 6, 19 |
| 334 | 239872 | 13, 8, 16, 15, 11, 17 | 420 | 419072 | 8, 17, 14, 10, 18, 13 | 506 | 659716 | 8, 17, 2, 19, 12 |
| 335 | 245760 | 16, 15, 14, 17 | 421 | 420352 | 9, 13, 17, 11, 14, 18 | 507 | 659776 | 8, 17, 6, 19, 12 |
| 336 | 262154 | 1, 18, 3 | 422 | 427009 | 0, 15, 10, 18, 17 | 508 | 664065 | 0, 17, 13, 9, 19 |
| 337 | 262155 | 0, 1, 18, 3 | 423 | 428040 | 3, 15, 11, 17, 18 | 509 | 664080 | 4, 17, 13, 9, 19 |
| 338 | 262185 | 0, 3, 18, 5 | 424 | 431360 | 12, 8, 17, 18, 10, 15 | 510 | 668416 | 19, 12, 8, 17, 13, 9 |
| 339 | 262200 | 3, 4, 5, 18 | 425 | 432640 | 15, 11, 17, 18, 9, 12 | 511 | 670720 | 13, 12, 19, 10, 11, 17 |
| 340 | 262275 | 0, 7, 18, 1 | 426 | 458760 | 16, 17, 18, 3 | 512 | 672769 | 0, 17, 14, 10, 19 |
| 341 | 262290 | 1, 18, 7, 4 | 427 | 458880 | 16, 17, 18, 7 | 513 | 672784 | 4, 17, 14, 10, 19 |
| 342 | 262304 | 5, 18, 7 | 428 | 463360 | 16, 17, 18, 9, 12 | 514 | 677120 | 8, 12, 19, 10, 14, 17 |
| 343 | 262320 | 4, 5, 18, 7 | 429 | 492544 | 16, 17, 18, 10, 15 | 515 | 690180 | 11, 17, 2, 19, 15 |
| 516 | 690240 | 11, 17, 6, 19, 15 | 549 | 952320 | 11, 17, 18, 19, 15 | 582 | 279560 | 18, 14, 10 |
| 517 | 698880 | 13, 9, 19, 15, 11, 17 | 550 | 983040 | 16, 17, 18, 19 | 583 | 149505 | 11, 14, 17 |
| 518 | 705280 | 19, 15, 14, 17, 8, 9 | 551 | 270976 | 9, 13, 18 | 584 | 279554 | 14, 10, 18 |
| 519 | 707584 | 19, 10, 14, 17, 11, 15 | 552 | 528912 | 12, 9, 19 | 585 | 558084 | 10, 15, 19 |
| 520 | 720900 | 16, 17, 2, 19 | 553 | 69920 | 8, 12, 16 | 586 | 100360 | 15, 11, 16 |
| 521 | 720960 | 16, 17, 6, 19 | 554 | 139584 | 13, 8, 17 | 587 | 139536 | 17, 13, 8 |
| 522 | 729600 | 16, 17, 13, 9, 19 | 555 | 528960 | 19, 12, 9 | 588 | 270880 | 18, 9, 13 |
| 523 | 738304 | 16, 17, 14, 10, 19 | 556 | 70016 | 16, 8, 12 | 589 | 528960 | 19, 12, 9 |
| 524 | 786435 | 0, 1, 18, 19 | 557 | 139536 | 17, 13, 8 | 590 | 70016 | 16, 8, 12 |
| 525 | 786450 | 1, 18, 19, 4 | 558 | 270880 | 18, 9, 13 | 591 | 69920 | 8, 12, 16 |
| 526 | 786465 | 0, 19, 18, 5 | 559 | 558084 | 10, 15, 19 | 592 | 139584 | 13, 8, 17 |
| 527 | 786480 | 4, 5, 18, 19 | 560 | 100360 | 15, 11, 16 | 593 | 270976 | 9, 13, 18 |
| 528 | 790530 | 1, 18, 19, 12 | 561 | 149505 | 11, 14, 17 | 594 | 528912 | 12, 9, 19 |
| 529 | 790816 | 8, 12, 19, 18, 5 | 562 | 279554 | 14, 10, 18 | 595 | 100354 | 16, 15, 11 |
| 530 | 794625 | 0, 13, 18, 19 | 563 | 279560 | 18, 14, 10 | 596 | 149508 | 17, 11, 14 |
| 531 | 794896 | 8, 13, 18, 19, 4 | 564 | 558081 | 19, 10, 15 | 597 | 279560 | 18, 14, 10 |
| 532 | 798720 | 12, 19, 18, 13 | 565 | 100354 | 16, 15, 11 | 598 | 558081 | 19, 10, 15 |
| 533 | 802832 | 4, 14, 18, 19 | 566 | 149508 | 17, 11, 14 | 599 | 139528 | 8, 17, 13 |
| 534 | 804865 | 0, 19, 18, 14, 11 | 567 | 279568 | 10, 18, 14 | 600 | 270849 | 13, 18, 9 |
| 535 | 808448 | 12, 9, 18, 14, 10, 19 | 568 | 558112 | 15, 19, 10 | 601 | 528898 | 9, 19, 12 |
| 536 | 809216 | 8, 11, 14, 18, 19, 12 | 569 | 100416 | 11, 16, 15 | 602 | 69892 | 12, 16, 8 |
| 537 | 819232 | 5, 18, 19, 15 | 570 | 149632 | 14, 17, 11 | 603 | 70016 | 16, 8, 12 |
| 538 | 821250 | 1, 18, 19, 15, 11 | 571 | 270880 | 18, 9, 13 | 604 | 139536 | 17, 13, 8 |
| 539 | 828928 | 13, 18, 10, 15, 19, 9 | 572 | 528960 | 19, 12, 9 | 605 | 270880 | 18, 9, 13 |
| 540 | 829696 | 11, 8, 13, 18, 19, 15 | 573 | 70016 | 16, 8, 12 | 606 | 528960 | 19, 12, 9 |
| 541 | 835584 | 19, 15, 14, 18 | 574 | 139536 | 17, 13, 8 | 607 | 100416 | 11, 16, 15 |
| 542 | 851970 | 16, 1, 18, 19 | 575 | 528898 | 9, 19, 12 | 608 | 149632 | 14, 17, 11 |
| 543 | 852000 | 16, 5, 18, 19 | 576 | 69892 | 12, 16, 8 | 609 | 279568 | 10, 18, 14 |
| 544 | 860416 | 16, 8, 13, 18, 19 | 577 | 139528 | 8, 17, 13 | 610 | 558112 | 15, 19, 10 |
| 545 | 870400 | 16, 11, 14, 18, 19 | 578 | 270849 | 13, 18, 9 | 611 | 149508 | 17, 11, 14 |
| 546 | 917505 | 0, 17, 18, 19 | 579 | 558081 | 19, 10, 15 | 612 | 279560 | 18, 14, 10 |
| 547 | 917520 | 4, 17, 18, 19 | 580 | 100354 | 16, 15, 11 | 613 | 558081 | 19, 10, 15 |
| 548 | 921856 | 8, 17, 18, 19, 12 | 581 | 149508 | 17, 11, 14 | 614 | 100354 | 16, 15, 11 |

1. A method of processing a point cloud including point cloud data of objects to create a representation of the objects, the method comprising:
superimposing a grid of cubes over the point cloud;
for each cube in the grid, fitting a plane to the points in the cube, using points in the cube and neighbouring cubes, to produce a cube plane, and using the cube planes to derive a surface mesh of polygons.

2. The method of claim 1 further comprising constructing at least one cube vertex plane, which is an average of the cube planes of the eight cubes sharing the vertex, and using the cube vertex plane for smoothing discontinuities in the surface mesh.

3. The method of claim 1 comprising determining the intersection of the cube plane with the vertexes and edges of the cube, to create a cube planar polygon.

4. The method of claim 3 comprising splitting the polygon into triangles, to form a triangle mesh.

5. The method of claim 4 comprising simplifying the triangle mesh, using at least one of the angle between neighbouring triangles, the angles within triangles, the areas of triangles, and/or by collapsing edges, by replacing nodes that comprise an edge of a triangle by a replacement single node.

6. The method of claim 1 comprising identifying break lines, where distinct surfaces in the point cloud intersect.

7. The method of claim 6 comprising using surface curvature to identify break lines.

8. The method of claim 6 further comprising using break lines to identify corners.

9. The method of claim 6 comprising using break lines to identify intersections between surfaces, separating along break lines and/or modelling the intersecting surfaces separately.

10. The method of claim 6 comprising closing consecutive break edges that form open edges or forks in the surface mesh.

11. The method of claim 1 comprising trimming the surface mesh to an estimate of the point cloud boundary, using non-shared edges of the surface mesh polygons.

12. The method of claim 11 comprising using the non-shared edges to create a boundary polyline, and using the boundary polyline to determine the boundary of the point cloud.

13. The method of claim 1 comprising texturizing the surface mesh, using texture coordinates associated with the surface mesh, for example, using texture coordinates for each vertex and a corresponding bitmap.

14. The method of claim 1 comprising identifying where adjacent lines represented by polygon nodes are approximately straight or at right angles, and adjusting nodes to form lines at straight or right angles.

15. The method of claim 1 comprising splitting a point cloud into sub clouds or regions, processing each sub cloud or region to create a sub cloud or region mesh, and fusing the sub cloud or region meshes.

16. The method of claim 15 wherein the regions comprise overlapping 2- or 3-dimensional tiles, and the fusing matches the meshes across tile edges or faces, for example, fusing surfaces to corresponding surfaces, preferably wherein fusing surfaces comprises matching and fusing one or more of nodes, edges, planes, triangles, at the interfaces.

17. The method of claim 15 wherein the regions comprise tiles and an overlap region surrounding each tile, preferably, wherein the length of each side of the tile and/or the overlap region is a multiple of a grid cube length.

18-19. (canceled)

20. The method of claim 15 comprising processing the sub clouds in parallel, for example, locally or remotely, such as in the cloud.

21. The method of claim 1 comprising representing the objects or surface mesh in a form suitable for use in further processing, such as for building representation, for example, Building Intelligence Modelling (BIM), for example, for creating floor plans and/or wall plans of a building.

22. (canceled)

23. An apparatus comprising means, such as a processor, for performing the method of claim 1.
